(19) United States
(12) Patent Application Publication
(10) Pub. No.: US 2011/0046990 A1
(43) Pub. Date: Feb. 24, 2011

(54) Model for Long-Term Language Achievement

(76) Inventor: Laura Jeanne Smith, Montclair, VA (US)

Correspondence Address: Laura J. Smith, RR 1, Box 668, Wintergreen Resort, VA, 22967, US

(21) Appl. No.: 12/475,567

(22) Filed: Aug. 18, 2009

(51) Int. Cl. G06Q 50/00; G06Q 10/00

(52) U.S. Cl. 705/7

(57) ABSTRACT

The Model for Long-Term Language Achievement is the framework for the National Language Achievement Framework, the Plan for Long-Term Language Achievement, and the associated national, individual and synchronized data management and reporting systems. The National Language Achievement Framework represents the processes for a nationwide system assessment, national coordination, transformation, and administration. The Plan for Long-Term Language Achievement includes materials and procedures for data collection, analysis, and reporting to provide a process and guide to conduct individual, program, organizational, system, and national assessments. The data management and reporting systems are designed to manage and report data to facilitate these processes. The reporting system includes a feature to develop customized national frameworks and process models.

### BACKGROUND

### National Language Achievement Framework; Data Management and Reporting System

The National Language Achievement Framework represents a synchronized process designed to facilitate nationwide system assessment, coordination, transformation, and administration of the foreign language education system in the United States. The associated data management and reporting system is designed to facilitate this process. The templates provided in this document include materials and procedures for data collection, analysis, and reporting associated with these processes. The nationwide system assessment serves as the national needs analysis to facilitate national language transformation and coordination. This system includes general templates and procedures for inserting, managing, and reporting specific data. The data management and reporting system may be customized to develop a Customized Language Achievement Software System (CLASS) that includes customized templates/reports for a specific system, nation, or entity.

The Plan for Long-Term Language Achievement is designed to be used with the National Language Achievement Framework as well as independently by individual teachers, learners, professionals, recruiters and personnel administrators and may be used as a guide to develop recommendations to improve proficiency and performance, as well as associated recruiting and performance management procedures The synchronized national data management and reporting system is designed to be used by all personnel in the language education system for reporting only or for data management of authorized data. The national system administrator may determine the level of access to data. The synchronized individual data management and reporting system is designed to be used by teachers, recruiters, personnel administrators, professionals, learners, and others as specified. The individual data management and reporting system is designed to be used by all language teachers, language learners, and language professionals. Materials and procedures are designed to be used independently or using the data management and reporting system. The Plan for Long-Term Language Achievement is designed to be used independently or with existing procedures for proficiency assessments, performance assessments, diagnostic assessments, means assessments, progress assessments, dynamic assessments, motivational assessments, and other assessments as specified.

The specification includes illustrations of materials and templates to be used for the data management and reporting system. The National Language Achievement Framework is designed to be administered by the president, a national language authority, or a designated representative. This system is designed to be used as to manage and report data associated with the foreign language education system; however, it may also be used for other national systems, such as second language education, education, and performance management. The data management and reporting system may also be used for other nationwide system assessments.

The data management and reporting system also includes a customizable feature that may be tailored to represent or report data associated with individual systems at the national, federal, state, and local levels to include representations of individual departments, agencies, organizations, schools, programs, offices, divisions, functions, languages, associated training, personnel, and learners. This framework includes a Plan for Long-Term Language Achievement which provides a process and reporting mechanism for implementing the Individual Language Learning Plans for individual learners. Additionally, Synchronized Recruiting Plans and Synchronized Performance Management Progress and Retention Plans may be used in conjunction with the Individual Language Learning Plan. These plans are designed to be used as a guide. This framework includes procedures for assessment, coordination, implementation and administration as well as a process for reporting, using a model or report feature. Text format is also available through the reporting feature.

Amended FIG. 1 replaces FIGS. 1-5 and all drawings (models and frameworks) submitted previously with the application. This figure represents all previous drawings and is used to 1) provide a comprehensive representation of the National Language Achievement Framework; 2) provide a framework to define the foreign language education system and associated processes; 3) provide a representation to describe the specifications and claims; and 4) provide a sample framework model that may be produced using the Model reporting feature (FIG. 1 also replaces FIG. 52).

### National Language Achievement

National Language Achievement refers to procedures used to conduct a nationwide system assessment associated with the administration and procedures for national language coordination and national language transformation (refer to FIG. 1). National Language Coordination describes a process, data management, and reporting system designed to synchronize policies, initiatives, plans, programs, resources, standards, and other data as specified associated with the foreign language education system. This includes a plan for National Language Transformation, which is a process designed to implement and manage change throughout the national system. These processes are combined in one synchronized system to provide coordination, data management, reporting procedures, and administration of the national system. The National Language Achievement Framework is designed to represent the foreign language education system from the policy through learner levels at all proficiency levels, from beginning and future learners to professional language use at native-like proficiency. This framework includes several associated processes to include change management; corporate and strategic planning; research, development, and evaluation; training and professional development; performance management; reporting, evaluation and advising; and continuous process and performance improvement, as well as associated processes related to administration, legislation, and oversight.

The National Language Achievement Framework also includes a customizable process modeling feature that may be used to report data associated with individual systems at the national, federal, state, and local levels to include representations of individual departments, agencies, organizations, schools, programs, offices, divisions, functions, languages, associated training, personnel, and learners. This framework includes a Plan for Long-Term Language Achievement which provides a process and reporting mechanism for implementing the Individual Language Learning Plans for individual learners. Additionally, Recruiting Plans and Performance Management Progress and Retention Plans may be used in conjunction with the Individual Language Learning Plan. These plans are designed to be used as a guide to develop plans to facilitate improved proficiency, increased performance, and improved associated recruiting and retention programs. This framework includes procedures for assessment, coordination, implementation and administration as well as a process and mechanism designed for reporting, and a design for process modeling procedures to facilitate the development of the customizable models and frameworks.

### Foreign Language Education System

The foreign language education system refers to language and associated language education and training provided for or by K-12 language programs, postsecondary language and associated language education programs, and Federal language schools, programs and associated training programs. Administration of this system involves a combination of associated processes to include corporate and strategic planning; research, development, and evaluation; training and professional development; recruiting and performance management; and performance and accountability reporting, advising and evaluation; and continuous process and performance improvement, in conjunction with associated legislative, administrative, and oversight processes. The system includes Federal, state, and local governments; and associated policies, initiatives, programs, and plans for individual departments, agencies, organizations, school systems, schools and universities, programs, offices, divisions, associated processes, and functions, as well as curriculum and instructional methods, development strategies, and recruitment and performance management programs associated with policies and initiatives. This system includes positive, negative, and neutral process flow, which may be linear or non-linear. Personnel include the national system administrator level, change agent level, policymaker level, administrator level, teacher level, and learner level. This includes language professionals, personnel administrators and recruiters, researchers, managers, supervisors, educators, staff, and future personnel and learners. Other entities are also associated with or influence this system, such as lobbyists, consultants, special interest groups, parents, clubs, groups, organizations, and other not specifically addressed.

### SUMMARY OF THE INVENTION

### Data Management and Reporting System

This data management and reporting system is designed to include software versions for the following:
1. National Language Achievement (NLAs)
2. Synchronized Language Achievement (SLAs)
3. Individual and Synchronized Language Achievement System (ISLAs)
4. Customized Language Achievement Software System (CLASS)

### National Language Achievement System (NLAs)

NLAs (FIG. 7) is a data management and reporting system designed to be used for data management and reporting at the national level. This is an individual system and may only be shared by users on the same network. NLAs may be used individually for nationwide system assessments; however, for national system coordination and reporting, NLAs must be used in conjunction with SLAs. When NLAs and SLAs are synchronized, NLAs users may have access to all features in both NLAs and SLAs; however, SLAs users may report to NLAs users but may not have access to NLAs features, unless permission is granted by the national system administrator. NLAs may be used independently to conduct, manage, and report data associated with nationwide system assessments and to facilitate coordination of national system data. Synchronized Language Achievement System (SLAs)

SLAa (FIG. 22) is a data management and reporting system designed to be used for reporting throughout the specified system. SLAs is designed to be used by all personnel associated with the system for reporting only. User access to the data management features may be granted by the system administrator. SLAs may be used to report data at all levels in the system. When SLAs is synchronized with NLAs, specified NLAs users may receive data from SLAs users. SLAs may be used independently to conduct, manage, and report data associated with program evaluations

### Individual and Synchronized Language Achievement System (I-SLAs)

I-SLAs (FIG. 31) is a data management and reporting system that is designed to be used by language teachers, learners, professionals, associated recruiters and personnel administrators. I-SLAs includes guides and procedures to conduct individual assessments and develop recommendations and plans for long-term language achievement. I-SLAs includes a feature to synchronize the individual version with other users on the same network, however, the user has the option to block this feature. I-SLAs may be used independently to conduct, manage, and report data associated with individual assessments.

### Customized Language Achievement Software System (CLASS)

CLASS (FIG. 54) is a customizable administrator version of the data management and reporting system. CLASS combines NLAs, SLAs, and I-SLAs versions and includes features for synchronization. CLASS may include additional features to provide a mechanism to administer national language coordination or the coordination of a national system as well as national language transformation and administration of system data. CLASS may be used to collect, analyze, manage, and report data associated with any process or entity associated with the specified system. CLASS includes features to manage and report data associated with administration, assessments, data collection, data analysis, data management, reporting, recommendations, legislations, and oversight at all levels for any entity associated with the system.

### DESCRIPTION

The data management and reporting systems are designed to be used for assessment, coordination, and administration of the foreign language education system in the United States; however, they may also be used to manage and report data associated with other national systems. The NLAs system may be used at the national system administrator level. NLAs may also be used to manage and report data associated with nationwide system assessments. Additional features may be added to the customized version. The SLAs system is designed for use by the following levels and others: national system administrator; system administrators; senior administrators; program administrators; personnel administrators; managers, supervisors, and staff; educators; learners, and professionals. SLAs may also be used to manage and report data associated with program evaluations. Individual and synchronized versions of the I-SLAs (Plan for Long-Term Language Achievement) are designed for use by language professionals; language learners and future learners; language teachers and educators; authorized personnel administrators and recruiters, and others. I-SLAs may also be used to manage and report data associated with individual assessments.

The system is designed to be used by personnel associated with the specified system for reporting for the functions and personnel they manage. The system administrator determines the level of user access to the data management system. All versions should include registration information and a license agreement. Measures for data security will be incorporated into the program during software development. Each user establishes a user identification and password to access the system.

### Design Features

Using the Model feature, the user may develop process and performance models to facilitate evaluation and reporting. Using the recommendations feature, the user may make recommendations and develop strategic plans. Using the Model feature, the user may develop and update the National Language Achievement Framework (national system framework model) Using the Change Management process feature, the user may plan, monitor, evaluate, and manage data associated with a public awareness and advocacy campaign, assessments, and other associated data. Using the data management and reporting system, the user may coordinate data at the national level to facilitate planning, monitoring, evaluation, and improvements for the system. The National Language Achievement framework should be administered by the national system administrator using the customizable language achievement software system (CLASS).

The administrator version, CLASS, does not synchronize with NLAs, SLAs, or I-SLAs versions. NLAs and SLAs may be synchronized; however, NLAs, SLAs, and I-SLAs may not be synchronized together to be used as the administrator version. I-SLAs does not synchronize with NLAs or SLAs versions. I-SLAs users may synchronize data with other I-SLAs users on the same network; however, I-SLA users have the option to block this feature. Individual versions of NLAs, SLAs, and I-SLAs are designed for data management and reporting associated with nationwide system, program, and individual assessments. CLASS is designed to be used for data management and reporting associated with assessment, coordination, transformation, administration, and oversight of national systems, such as the foreign language education system.

These processes may be conducted independently; however, the associated materials, data management, and reporting systems are designed to facilitate these processes. If these processes are conducted without the data management and reporting software design, it is necessary to use numerous copies of each template to complete each process for each entry. The data management and reporting software design is recommended and includes a process modeling feature to report data.

Data Management and Reporting (includes Descriptions of the Several Views of the Drawings)

A data collection and reporting process is used to administer the nationwide system assessment, coordination, and transformation. Data are inserted into the tables illustrated in this document to complete the assessment. After the assessment is complete, data may be synchronized for national language coordination, and data coordination may be administered using CLASS. Process and performance modeling procedures are used to report data using a process modeling system. The reporting system for the National System Framework model is designed to provide specific reporting procedures to develop plans for process and performance improvement for individual systems, programs, learners, personnel, and other entities. The reporting system is designed to provide general user access to input data for reporting and includes a reporting feature. The data management and reporting system is designed for use by authorized users to view reported data, import data, design plans for continuous process and performance improvement, monitor and evaluate data; make recommendations, manage data, and report data using the materials, tables, and process modeling features.

### National Language Achievement System—Nationwide System Assessment

FIG. 6 represents the system report summary or System Profile (accessed by clicking on System Profile (refer to FIG. 7). Click on the selection “Nationwide System Assessment” to enter the nation. Data are collected and inserted in the templates listed in FIGS. 6 through 14 to complete the nationwide system assessment. Data are automatically saved to the System Profile when data are entered into the system. Click on a word to move to another page to insert data. The user may link to data for each selection in the report by clicking on a word. Each selection includes features for goals, resources, expected outcomes, outcomes, goals met, recommendations for improvement, projected needs and objectives, long-term strategic plans, and other data as specified. Selections in this report include the nation, system, policies, initiatives, departments, agencies, organizations, states, schools, programs, offices, divisions, personnel offices, curriculum and instruction, subjects, languages, performance, proficiency, functions, and other data as specified. Selections associated with performance data include policymakers, administrators, personnel administrators, managers, supervisors, recruiters, researchers, teachers, staff, learners, professionals, language professionals, future personnel, other associated personnel, and others as specified.

FIG. 7 represents the data management and reporting feature for NLAs. This level provides data management and reporting of data for the specified system. Data are inserted, managed, or reported for selections listed in the templates The white buttons in the data management and reporting system (in FIG. 7) on the left are used for data management of data collected during a nationwide system assessment. The dark blue buttons on the right are used for planning, monitoring, and evaluation of associated processes. The top button marked “National Language Achievement” is used to insert, evaluate, monitor, and report data associated with the administration of the National Language Achievement. Use the dark blue buttons below the National Language Achievement feature to manage and report data associated with assessment, coordination, transformation, and administration. Use the light blue buttons to insert existing strategic plans, develop strategic plans using recommendations, or synchronized data for policies, plans, programs, and standards. The system profile provides data collection and data management features for the entire system. FIG. 7 represents the features for the data management and reporting system.

FIG. 7 represents the National Language Achievement software version as well as the national system administrator level in the Synchronized Language Achievement software version when synchronized with SLAs. NLAs may also be used independently to conduct national system assessments of other systems. The national system administrator may authorize other users to access this level and may specify the level of access for each authorized user. This level in the system may receive data and reports from other users in the synchronized or customized systems at any level, however, may not transmit data to lower levels. This level includes a national System Profile feature that allows the user to enter or manage data associated with the specified system, to include departments, agencies, organizations, programs, functions, curriculum and instruction, and personnel and learners. The user may also enter and manage data associated with legislation, oversight, change management, research and development, education and training, professional development, performance management, reporting, Plans for Long-Term Language Achievement, and associated processes. The user may select features to develop plans, monitor progress, evaluate data, or develop, manage or view recommendations. The user may develop frameworks, process models, process maps, process flow diagrams, and organizational charts using the Model feature. The report feature allows the user to report data in text, table, or model format.

The user may insert or manage strategic plans and synchronized recommendations, plans, programs, standards, and other data specified by the user. These features link with associated features for Assessment, Coordination, Transformation, and Administration. The National Language Achievement feature links to a table to enter or manage data associated with assessment, coordination, transformation, and administration (FIG. 8). In this table, the user may click on each of these words to link to more detailed information about data associated with each feature. Each feature includes goals, resources, expected outcomes, outcomes, goals met, and recommendations for improvement, projected needs and objectives, long-term strategic plans and other data specified by the user.

The assessment feature (FIG. 9) links to a template that includes data associated with assessments. The user may enter or manage data for the nation, policies, initiatives, operations, and programs (including federal programs, K-12 programs, postsecondary programs, and federally-funded programs) as well as personnel. The user may link to specific data for each selection by clicking on the word (represented in FIGS. 10-13). The user may enter or manage data associated with goals, resources, expected outcomes, outcomes, goals met, and recommendations for improvement, projected needs and objectives, long-term strategic plans and other data specified by the user.

The Model and Report features may be used to evaluate data to make recommendations, manage data, or report data in table, model, or text format. The model feature may be used to develop national frameworks, performance and process models, process flow diagrams, and organizational charts. Models may also be linked to reports or selected data in reports. Data inserted into reports are automatically inserted into the system summary report (System Profile) and may be viewed using the system profile. The national system administrator may determine the level of user access to this feature. Reports may also be generated and reported by other users. Data reported to the system administrator by other users in the SLA's version are automatically saved to the system report summary. The system administrator may also select to use or block the automatic report settings which may automatically include the date, time, and user identification on reports received into the system by other users.

### Nationwide System Assessment: National Language Transformation (FIGS. 14-21)

The Transformation feature on the National Language Achievement page links to this section. This feature includes selections for National Language Transformation (FIG. 14); Foreign Language Education System (FIG. 15); Policies and Initiatives (FIG. 16); System Data (FIG. 17); Functions (FIG. 18); Curriculum and Instruction (FIG. 19); Personnel and Learners (FIG. 20); and the System Profile (FIG. 21). The National Language Transformation feature (FIG. 14) includes selections for assessment, implementation, coordination, and administration. The user may link to data for each selection by clicking on a word. Each selection includes features for goals, resources, expected outcomes, outcomes, goals met, recommendations for improvement, projected needs and objectives, long-term strategic plans, and other data specified by the user. The Foreign Language Education System selection includes data associated with national, federal, state, and local systems. More detailed information may be accessed by clicking on each word. Each selection includes data associated with goals, resources, expected outcomes, outcomes, goals met, recommendations for improvement, projected needs and objectives, long-term strategic plans, and other data as specified by the user.

FIGS. 16-21: The user may specify the system level (national, federal, state, local) by clicking on a word. Each selection includes data associated with goals, resources, expected outcomes, outcomes, goals met, recommendations for improvement, projected needs and objectives, long-term strategic plans, and other data as specified by the user.

The Policies and Initiatives (FIG. 16) selection includes data associated with the national, federal, state, and local systems. This template includes selections for policies, initiatives, programs, plans, standards, procedures, legislation, and oversight. The System Data (FIG. 17) selection includes data for departments, agencies, organizations, and programs. The Functions (FIG. 18) selection includes data associated with the executive administrator, senior administrators, program administrators, personnel administrators, managers, supervisors, professionals, interpreters, translators, applied linguists, researchers, trainers, professors, teachers, assistants, staff, learners, and other personnel as specified.

The Curriculum and Instruction (FIG. 19) template includes selections for subjects, languages, materials, and methods. The Personnel and Learners (FIG. 20) template includes selections for policymakers, administrators, personnel administrators, managers, supervisors, recruiters, researchers, teachers, staff, learners, professionals, language professionals, future personnel, and other personnel as specified. The System Profile (FIG. 21) template includes selections for the system, policy, initiative, department, agency, organization, state, school, program (Federal, K-12, post-secondary); office, division, personnel offices, curriculum and instruction, subjects, languages, performance, proficiency, and functions.

### Synchronized Language Achievement System (SLAs)

The synchronized language achievement version includes features that allow the user to enter, manage, model, and report data associated with programs, missions and objectives, plans, programs, and operations; process and performance data; curriculum and instruction; and personnel and learners as well as legislation, oversight, change management, strategic planning, research and development, education and training, professional development, performance management, reporting, the Plan for Long-Term Language Achievement, and other associated processes. The user may manage data for the authorized level, data, or features using the program profile and recommendations feature. The level of assess is determined by the system administrator for each level and overall, by the national system administrator. Other features allow the user to develop plans, monitor progress, or evaluate data. The user may report data using the Model or Report feature. The model feature allows the user to develop frameworks, process models, process maps, process flow diagrams, and organizational charts. The Report feature allows the user to report data in table format, text format, or model format. Data may be reported to specified users at higher levels in the system (the senior system administrator for each level determines the specified users for reporting purposes as well as the level of access for each user). The user may select features to develop plans, monitor progress, evaluate data, or develop, manage or view recommendations. The user may develop frameworks, process models, process maps, process flow diagrams, and organizational charts using the Model feature. The report feature allows the user to report data in text, table, or model format.

FIGS. 23-30: The Programs (FIG. 23) feature includes selections for Federal, K-12, Post-secondary, and other programs specified by the user. Click on each word to enter or manage detailed data about each selection. This template includes selections for data associated with goals, resources, expected outcomes, outcomes, goals met, recommendations for improvement, projected needs and objectives, long-term strategic plans, and other data as specified.

FIGS. 24-27 include selections for programs at the federal, K-12, postsecondary, and other levels. Each selection includes selections for goals, resources, expected outcomes, outcomes, goals met, and recommendations for improvement, projected needs and objectives, long-term strategic plans and other specified data. These selections are listed at the top of each template associated with FIGS. 24-27. The Language Program Data (FIG. 24) feature includes selections for missions, objectives, plans, operations, processes, performance data, proficiency assessments, performance assessments, diagnostic assessments, motivational assessments, means assessments, needs assessments, training, professional development, performance management, and other specified data. The Curriculum and Instruction (FIG. 25) feature includes selections for languages, subjects, standards, materials, and methods.

The Personnel and Learners (FIG. 26) feature includes selections for policymakers, administrators, personnel administrators, managers, supervisors, recruiters, researchers, teachers, staff, learners, professionals, language professionals, future personnel, and other personnel as specified. The Change Management (FIG. 27) feature includes selections for assessments, recommendations, public awareness and advocacy, transformation roadmaps, coordination, implementation, administration, programs, personnel, learners, and other specified data. The Strategic Planning (FIG. 28) feature includes options for System, Process, and Performance for all selections. Each template includes selections for data associated with goals, resources, expected outcomes, outcomes, goals met, and recommendations for improvement, projected needs and objectives, long-term strategic plans and other data as specified. These selections are available for each of the following selections on this template associated with systems, processes, and performance data: national, federal, state, local, k-12, post-secondary, future learners and professionals, personnel, policies, programs, operations, legislation, oversight, research, development, and evaluation; training and professional development; performance management; reporting; and other specified data. Click on each word to enter or view data associated with each selection.

The Research, Development, and Evaluation (FIG. 29) feature includes selections associated data at the national, federal, state, local, K-12, and post-secondary levels. Click on each word link to templates for each selection. Each selection includes selections for data for goals, resources, expected outcomes, outcomes, goals met, recommendations for improvement, projected needs and objectives, and long-term strategic plans.

The Performance Management (FIG. 30) feature includes links to research, development, and evaluation; professional development; assessments; best practices; education and training; performance management; recommendations, and collaborative resources. Each template includes sections for goals, resources, expected outcomes, outcomes, goals met, recommendations for improvement, projected needs and objectives, and long-term strategic plans. These features and selections are available for data associated with subjects, languages, curriculum, assessments, methods, strategies, materials, resources, professional development, proficiency, performance, collaborative resources, pilot programs, teachers, learners, recruiting, retention, and other specified data.

### Individual and Synchronized Language Achievement System (I-SLAs): FIGS. 31-49

The Plan for Long-Term Language Achievement (FIG. 31) includes the Individual Language Learning Plan, the Recruiting Plan, Performance Management Progress and Retention Plan, Synchronized Plan for Long-Term Language Achievement, and Performance Management Progress and Retention Plan. Other features link to the individual's mission data, coordination team, objectives, and outcomes. The data management and reporting features include background data about the learner or professional as well as data collected, analyzed, and reported associated with proficiency assessments, performance assessments, motivational assessments, and progress assessments. There is also a link to process and performance data. All data entered may be viewed and managed using the Individual Profile feature. Using this feature, the user may manage data for all reports associated with the specified individual. The recommendations feature link to recommendations and strategic plans for the specified individual. Other features include functions that allow the user to Develop a Plan, Monitor Progress, and Evaluate Data.

The user may select the Model feature to develop process models, process maps, process flow diagrams, and/or organizational charts. The Report feature allows the user to enter and report data selected using any combination of the templates listed in this section. The user specifies where or to whom the data are transmitted. Data may be reported using text formats, table formats, or models. The user has the option to synchronize the Plan for Long-Term Language Achievement with the Coordination team in part or in its entirety. The user also has the option to block this feature. The user selects what data may be synchronized and may select to coordinate data with members of the coordination team. Only the synchronized versions have features for coordination and synchronization with the coordination team. Individual versions do not have these features.

The Individual Language Learning Plan is used for individual assessments. The report includes background data, assessments, and plans for planning, monitoring, evaluation, and improvement. This may be synchronized with the Recruiting Plan, which may also be synchronized with the Performance Management Progress and Retention Plan. The Background Data report (FIG. 32) includes data such as name, school, program, location, language proficiency, language use, position or desired position, mission, functions, required performance and proficiency levels, goals, age, gender, language learning history, reasons for current language study, other languages and proficiency test data, educational background, professional background, and other information that may be specified by the user.

The Synchronized Plan (FIG. 33) includes a report to include data for coordination. This includes the learner, coordinator, recruiter, teacher, academic advisor, research advisor, advisor, and other personnel as specified by the user. Data about these individuals include name, title, program, contact information, and other data as specified by the user.

This includes selections for proficiency assessment, performance assessment, means assessment, and motivational assessment. The proficiency assessment data management feature is used to collect, analyze, and report data associated with an individual's proficiency, to include pre-test and post-test data. Data may include proficiency assessments for speaking, listening, reading, writing, and cultural competence, as well as other variables as specified. The performance assessment includes data associated with the performance level, application, knowledge, skills, and abilities. The means assessment includes data associated with learning styles, learning strategies, cognitive styles, personality, motivations, interests, perceived abilities, self-concept, information processing, strategy selection, linguistic development, cognitive development, motivational development, strategy regulation, aptitude, and other data as specified. Data may be reported for preferences, strengths, weaknesses, limitations, recommendations for improvement, and other recommendations. Data may be managed using the Individual Profile feature, the model feature, or the report feature. The learning processes feature may be used to enter and manage data associated with the individual's learning and associated processes, such as linguistic development, cognitive development, motivational development, strategy development, language transfer, strategy regulation, change management, and other features as specified. These data may be reported using the process modeling feature, table feature, or as text.

The motivational assessment may be used to report data associated with an individual's motivation in order to evaluate the primary source of motivation, associated motivational orientations, and influencing variables. The specified goals may be used to determine the level of proficiency and performance required for the position in order to develop a Plan for Long-Term Language Achievement. Use this report feature to conduct a motivational assessment in order to make recommendations to facilitate the development of motivation to persist in language learning to the required level of proficiency and performance. After conducting the assessment, insert data in the table. Use the model feature to develop a model of the individual's language learning motivation and associated processes. The user may view the report summary by clicking on the Individual Profile button.

It is recommended that the assessments determined to be the best practice for the program type during the nationwide system assessment be used as the standard assessments for the specified programs.

### Synchronized Plan for Long-Term Language Achievement

This plan is designed to help the recruiting process. If the learner indicates goals that are a match with a recruiter's interests, this plan may be used to increase proficiency and improve performance to prepare the learner for professional language use at the required proficiency and performance level. (Note: the user may block this feature in individual versions of I-SLAs).

This plan combines the Individual Language Learning Plan and results of the Learner Profile to design a Synchronized Recruiting Plan and a Synchronized Performance Management Progress and Retention Plan. The coordinator, in conjunction with the teacher and learner, facilitates the Synchronized Plan. Each member of the synchronized team should insert goals in the template below. The coordinator has access to all data and should facilitate the development of the plan in conjunction with learner's input. The recruiter has access to data input by the recruiter and authorized data, the teacher has access to data input by the teacher and authorized data, and the learner has access to data input by the learner. The learner may authorize access of data to any team member. Other features are also available, such as an online journal, additional surveys, observation journals, plans for practiced-practical application in a semi-authentic and authentic work environments, and recommendations to facilitate the development of motivation to persist in language learning to the required level of proficiency. In the university environment, the plan should be designed to help the learner achieve the learner's specified language, learning, career, and associated goals.

Insert data into the templates listed in the figures in this section. Determine what input is necessary to achieve goals. Determine what methods may be used to provide input and development strategies to develop the necessary proficiency and performance level. Insert or manage data using the data management and reporting system. The user may conduct assessments or insert results from existing assessments, develop plans, monitor and evaluate progress, make recommendations, and manage and report data.

The Synchronized Recruiting Plan may be used to recruit individuals for specific positions or functions.

### Synchronized Performance Management Progress and Retention Plan

The coordinator of the synchronized team may work in conjunction with the other team members as well as the supervisor of the learner's position to complete this template. If this plan is being used in conjunction with the Synchronized Recruiting Plan, these plans may be synchronized and managed using the Synchronized Plan for Long-Term Language Achievement feature in the data management and reporting system. Insert post-test data in the template below. In the data management system, the data from the Learner Profile may be automatically inserted. Evaluate data. Following the same procedures described in the Synchronized Recruiting Plan, develop the Performance Management Progress Plan for Stage 4 (and other stages as necessary when developing new knowledge, skills, and abilities). This may be used to determine and develop required proficiency and performance levels for specific functions.

The Synchronized Performance Management and Retention Plan is used in conjunction with the Plan for Long-Term Language Achievement for personnel who have already been recruited or are being recruited. Data may be inserted to manage or report data associated with this plan. This plan is used for individual performance management of personnel associated with the system. This report describes the individual's position and career goals. This may be used to determine the required level of proficiency and performance for long-term strategic planning. This plan includes a proficiency, performance, and motivational assessment. The user may use the Plan for Long-Term Language Achievement feature to collect data, analyze, and report data to complete this report and insert data associated with the performance management plan, incentives for retention, and recommendations and planning for improvement.

### I-SLAs Reporting

Report data in table format using the report feature. A text feature is also available using the report feature. FIG. 51 represents performance and accountability reporting for individual personnel. This report may be used for annual accountability reporting associated with performance management. Reported data may include the name of the individual, program, associated policy or initiative, language, positions, associated resources, and outcomes. Outcomes include goals, expected outcomes, actual outcomes, goals met (or not met), recommendations, and strategic planning. These data may be reported associated with recruiting, training, proficiency, performance, application, knowledge, skills, abilities, progress, improvement, professional development, performance management, retention, or other features specified by the user.

National Language Achievement—Administration using CLASS

The national system administrator administers the national data management and reporting system. At this level, the data management and reporting system is designed to facilitate all phases of the National Language Achievement Framework and includes all features of NLAs, SLAs, and I-SLAs. to provide features in the system to collect, evaluate, manage, and report data using the features listed in FIG. 54. Additional features may be added to the customized version.

### Administration

FIG. 54 represents the feature used for administration of the system by the system administrator. This features links to the assessment, coordination, and transformation features. The administrator may use this feature to insert, manage, model, or report data associated with management plans, progress plans, pending legislation, committees, progress improvement, awareness and advocacy, assessments, process models, goals, recommendations, the national framework, operations, white papers, policies and initiatives, special interest groups, performance improvement, oversight, surveys, organizational charts, outcomes, and national reports. The administrator may use model features to design, manage, or report data associated with national, state, or local systems, departments, organizations, programs, schools, processes, functions, performance, proficiency, personnel, or learners. Data may be reported as a process model, process map, process flow, or organizational chart using the process modeling feature, or in text or table format using the report feature.

In the administrator version, CLASS, the user may enter, manage and report data associated with nationwide, program, and individual assessments. The user accesses the profiles for the entity using the Profile features and specifies the Profile: System Profile, Program Profile, and Individual Profile. The user may also develop plans, monitor progress, and evaluate data using these features. The user may develop frameworks, process models, process maps, diagrams, and organizational charts using the Model feature. Data may be reported in table, model, and text format. The Model and Report features may be linked so that reports may be accessed through frameworks and models. In the administrator version, CLASS, the national system administrator and authorized users may also monitor other users in the system using the “Monitor Progress”. CLASS may also include additional features associated with “legislation” and “oversight”.

### Process Modeling and Reporting

The National System Framework Model (FIG. 1) is a customizable framework model which provides a process for developing customizable national frameworks, process models, process maps, diagrams, and organizational charts to represent or report data for processes and personnel associated with the national systems as well as individual systems at the national, federal, state, and local levels to include individual departments, agencies, organizations, schools, programs, offices, divisions, functions, curriculum and instructional methods, languages or other subjects and associated training; personnel and learners, and other data as specified. This data collection, analysis, and reporting process requires a specific process for process and performance modeling, analysis, and reporting. This feature may used to for reporting and to develop recommendations for continuous process and performance improvement.

### Process Modeling Feature (Including Descriptions of the Drawings, FIGS. 1, and 53)

FIG. 1 provides a sample of a framework that may be developed using the Model reporting feature. FIG. 53 provides a representation of the figures used in the process modeling system and includes basic codes that the user may select to build national or system frameworks, process and performance models, process maps, process flow diagrams, and organizational charts. Other symbols, colors, line styles, shading, or additional features may be added by the system administrator. Frameworks, models, maps, diagrams, and organizational charts may also be described using a text description or a table using the report feature. The user may report data using the report feature. Additional features may be added to the administrator version.

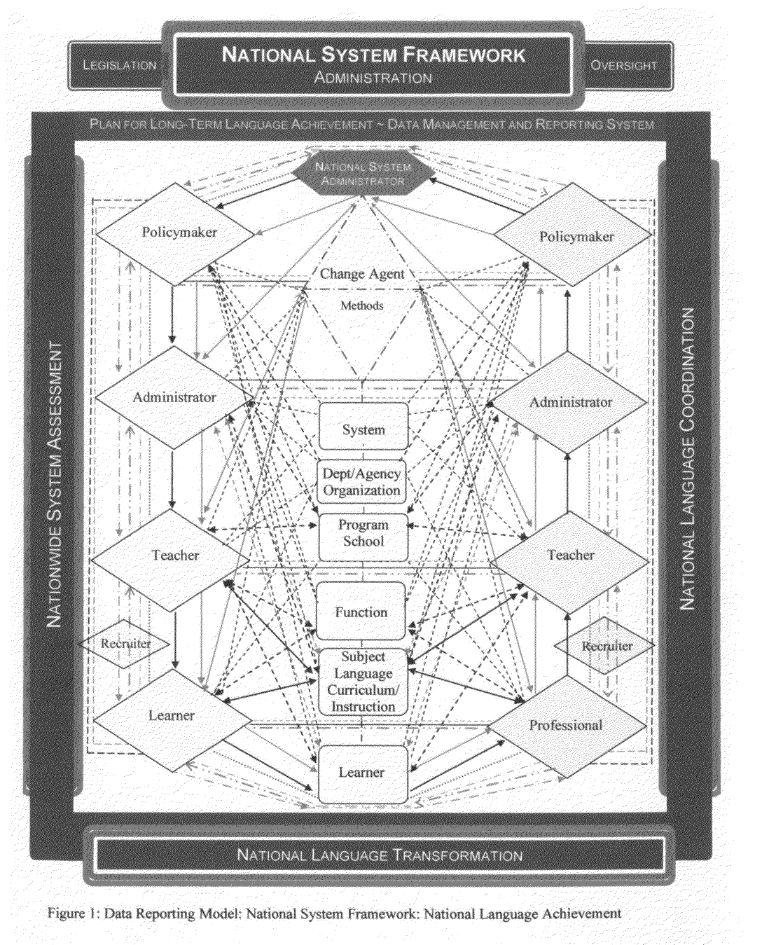

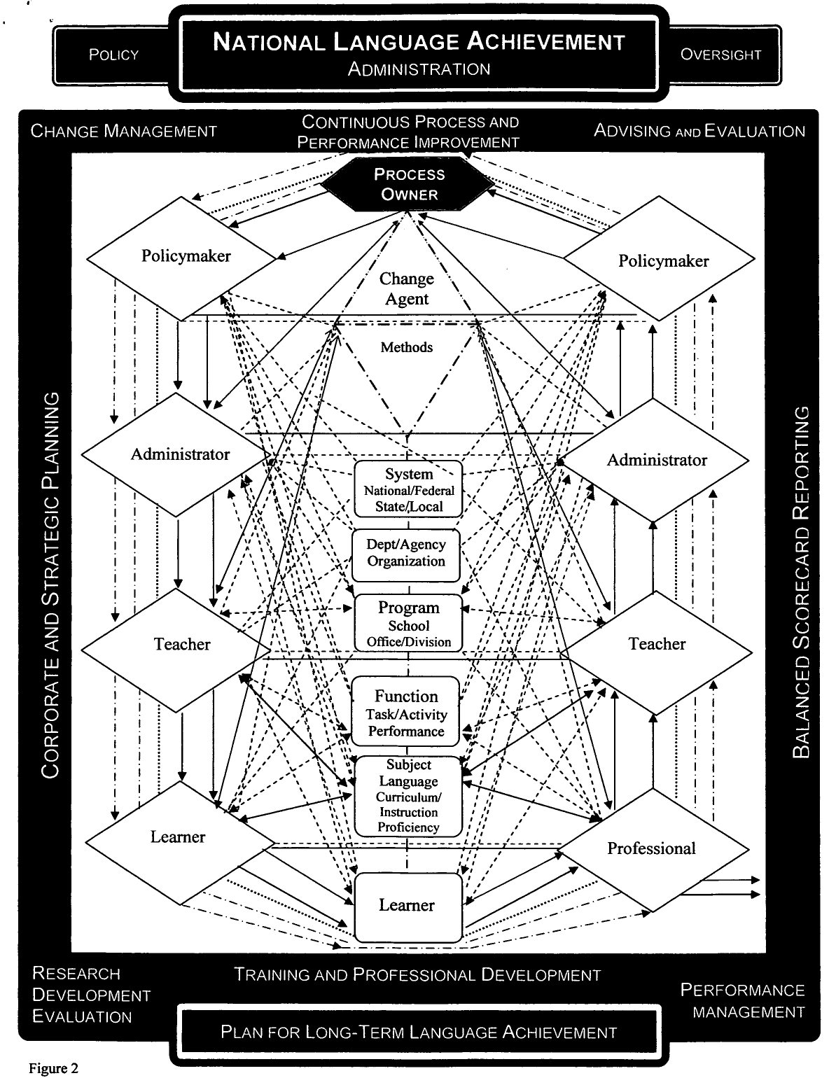

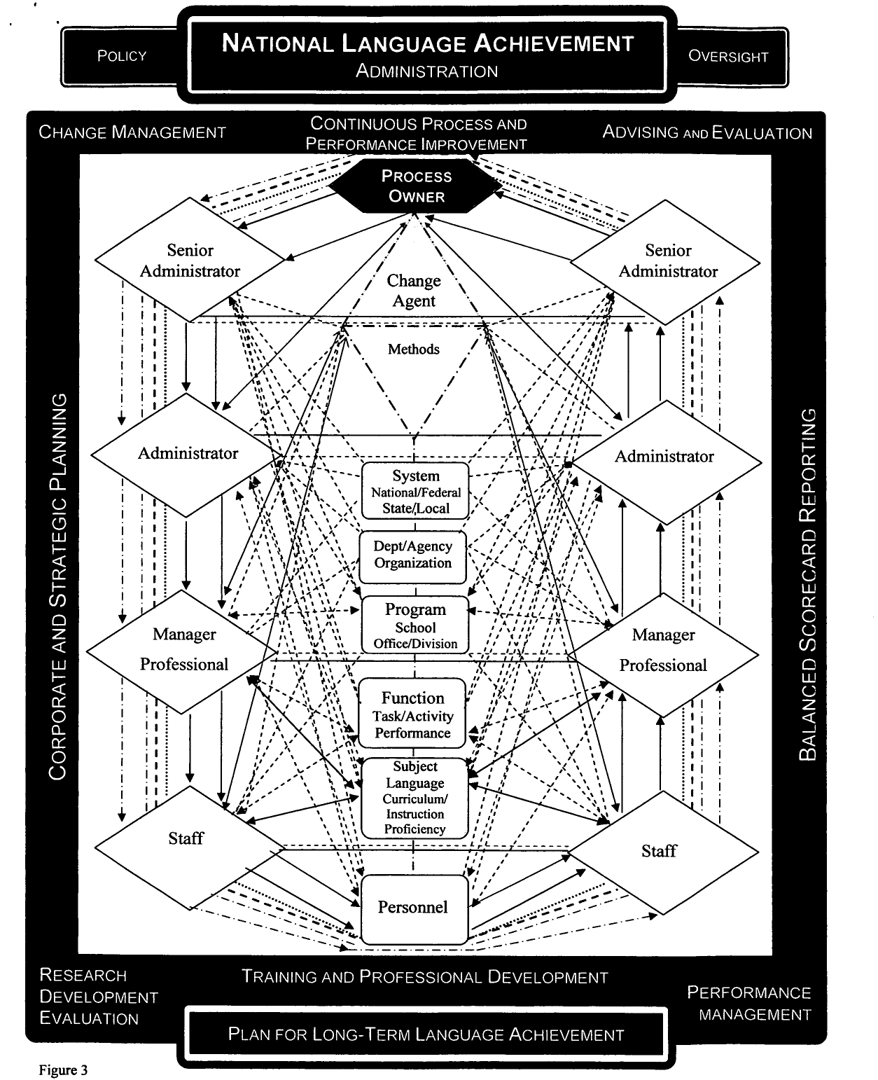

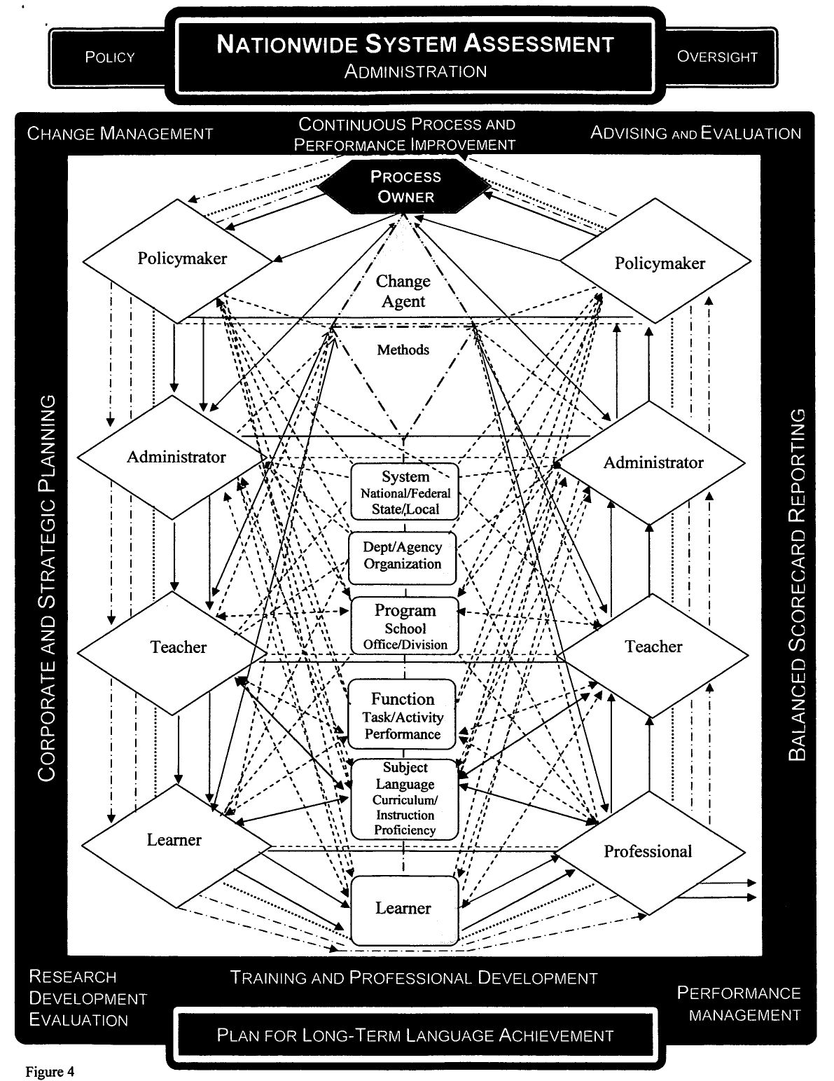

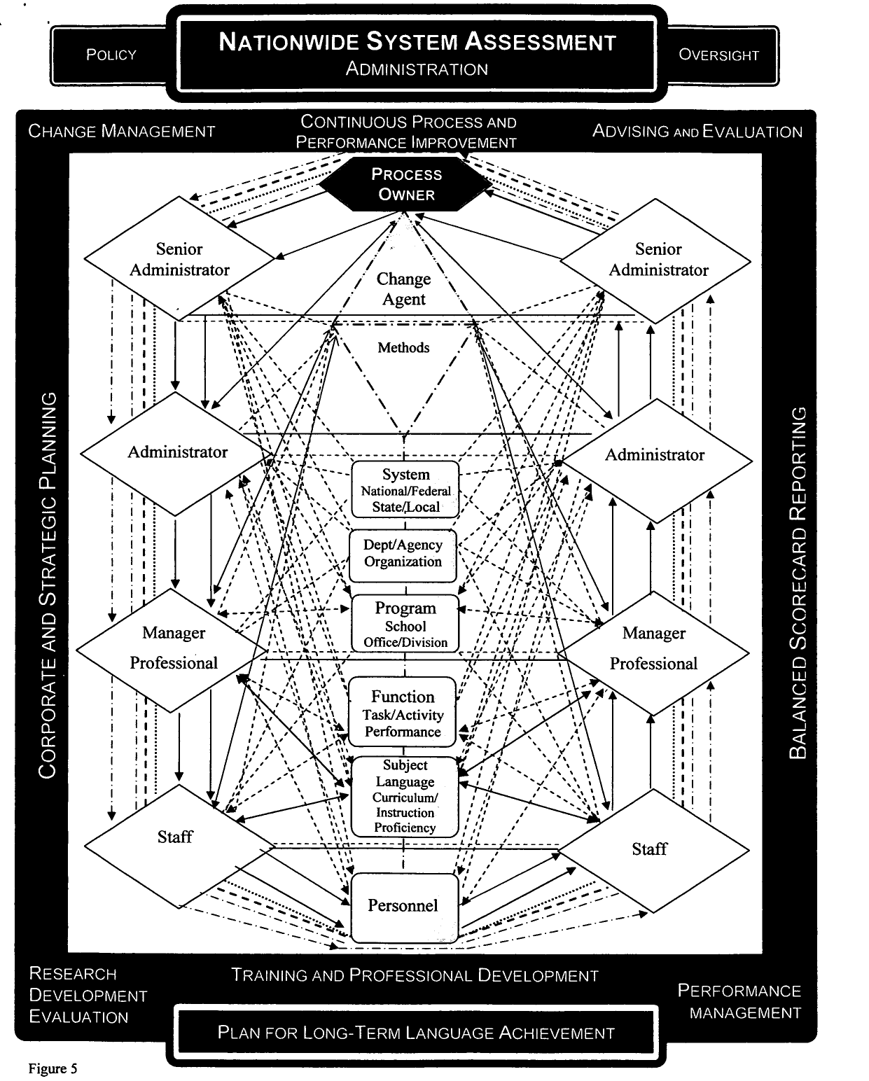

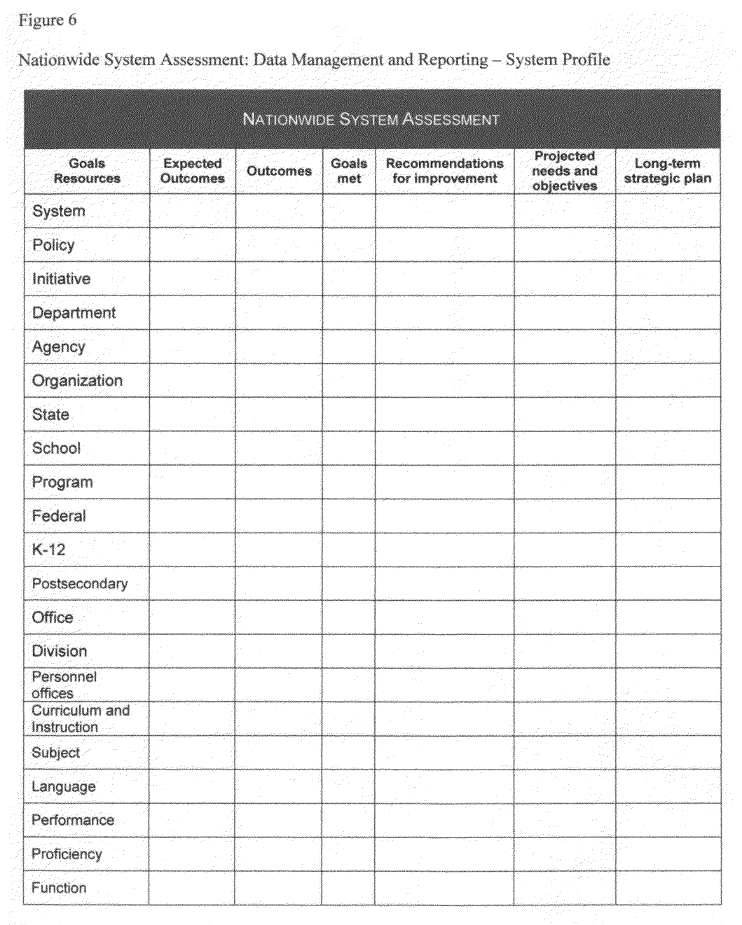

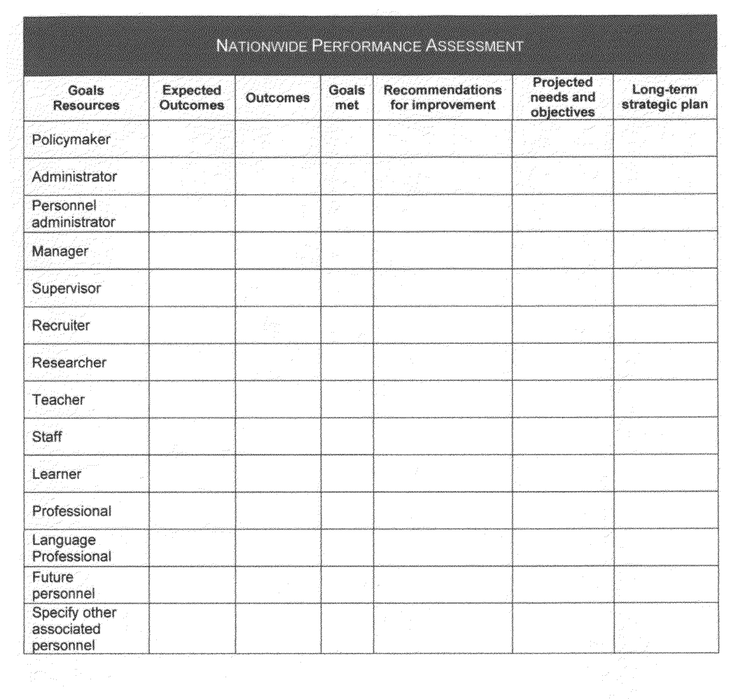

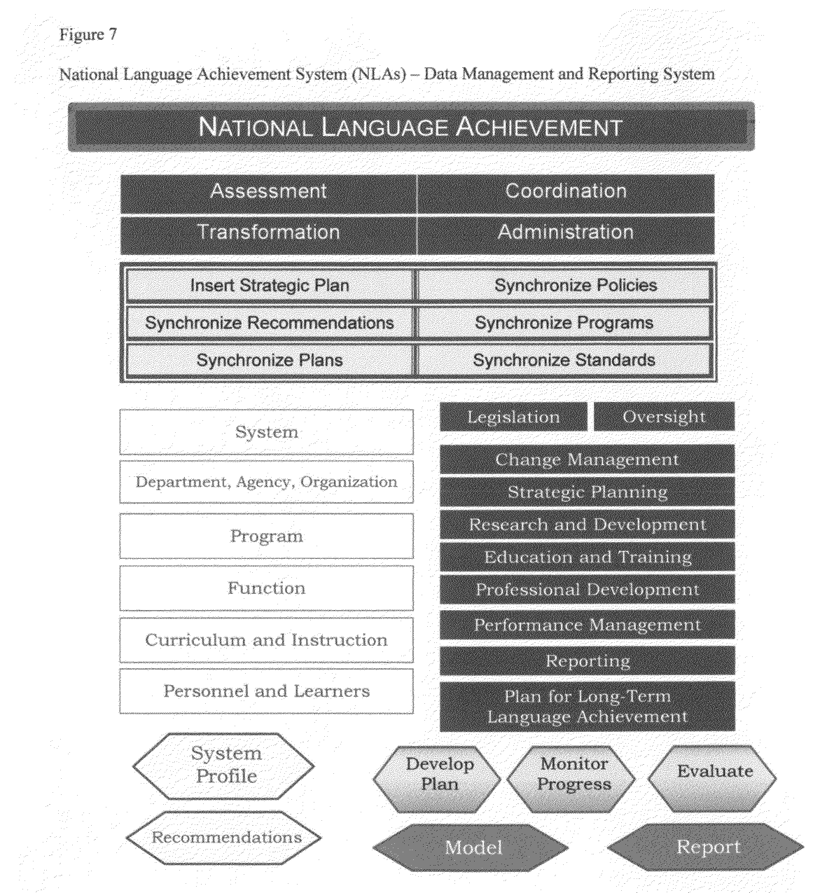

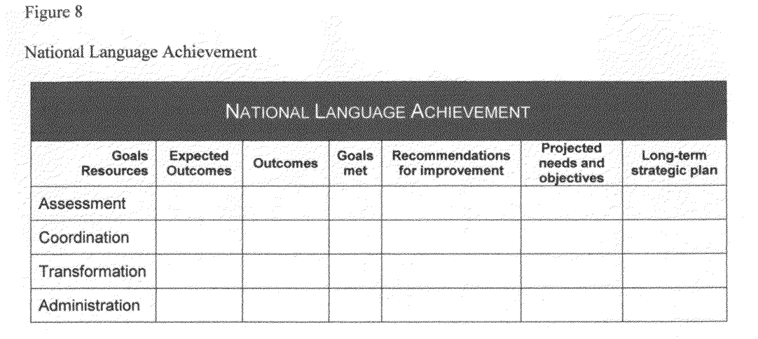

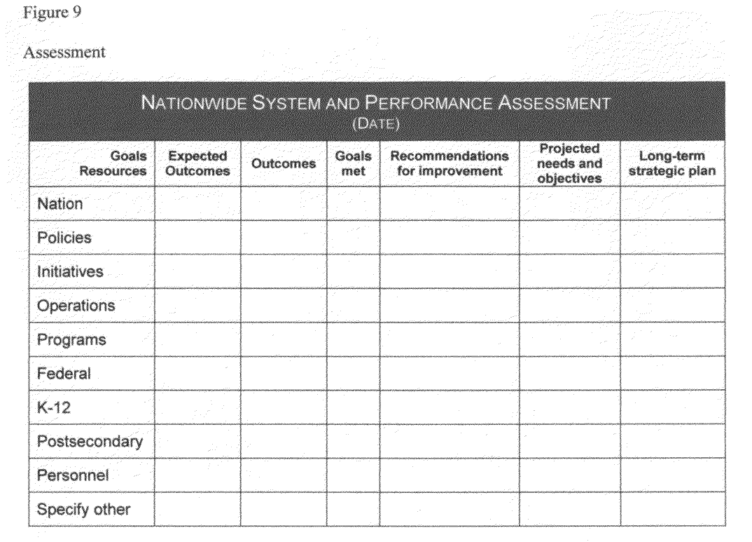

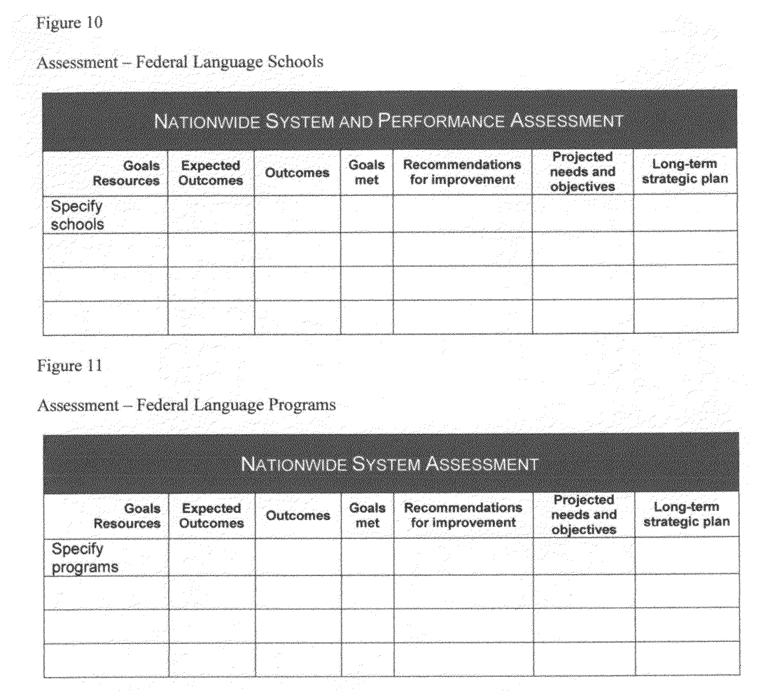

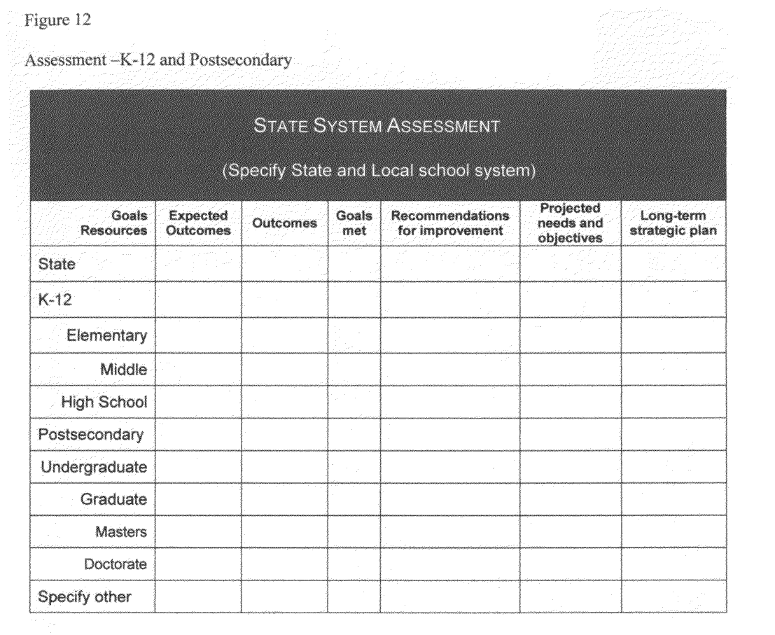

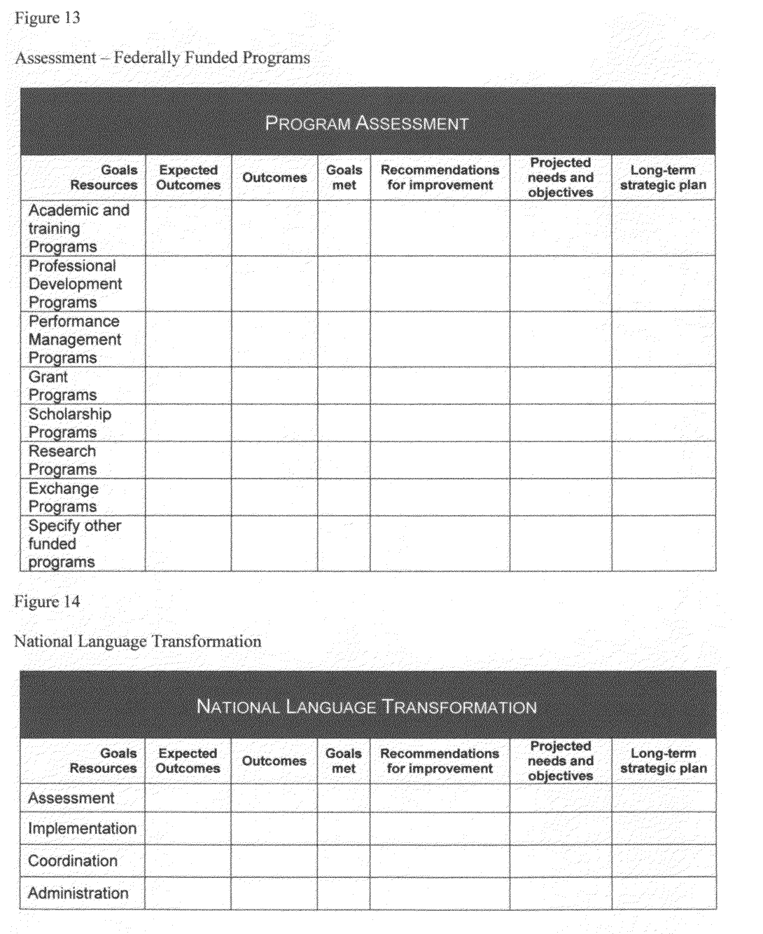

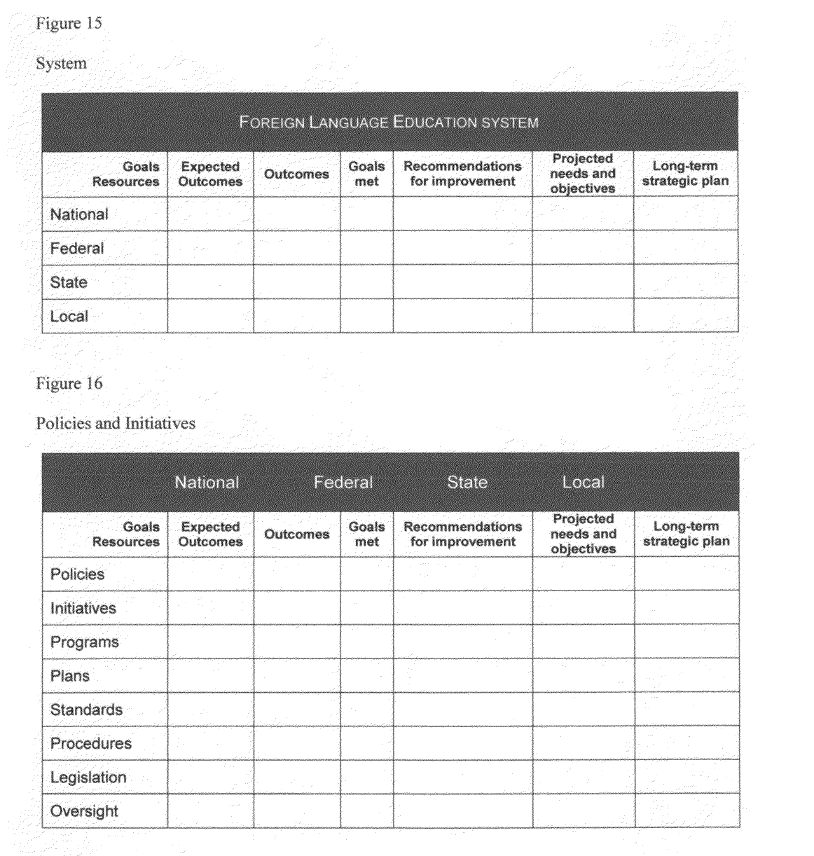

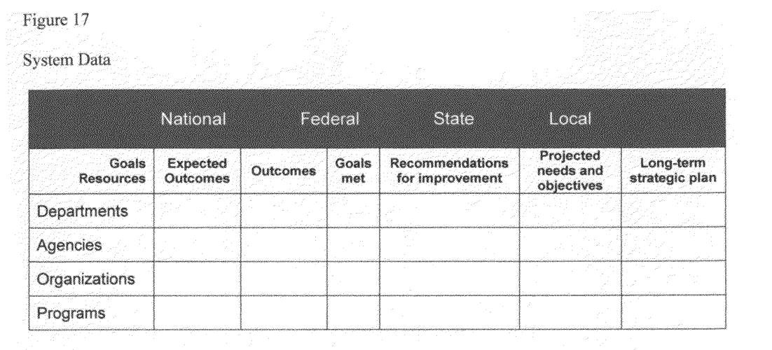

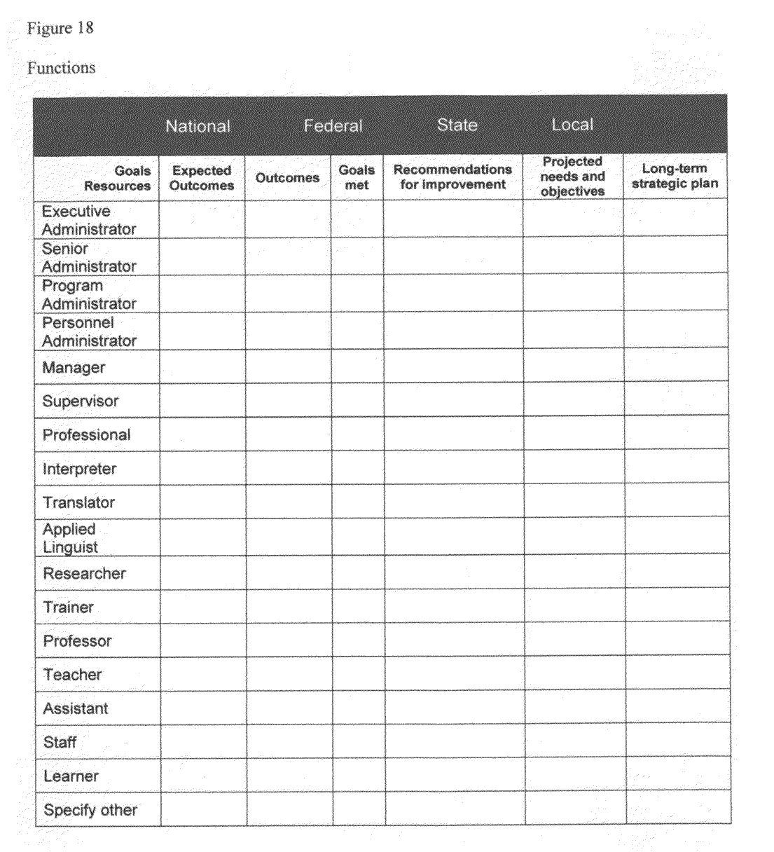

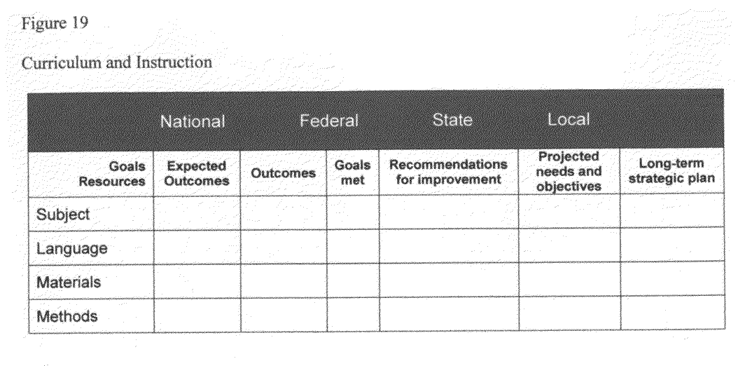

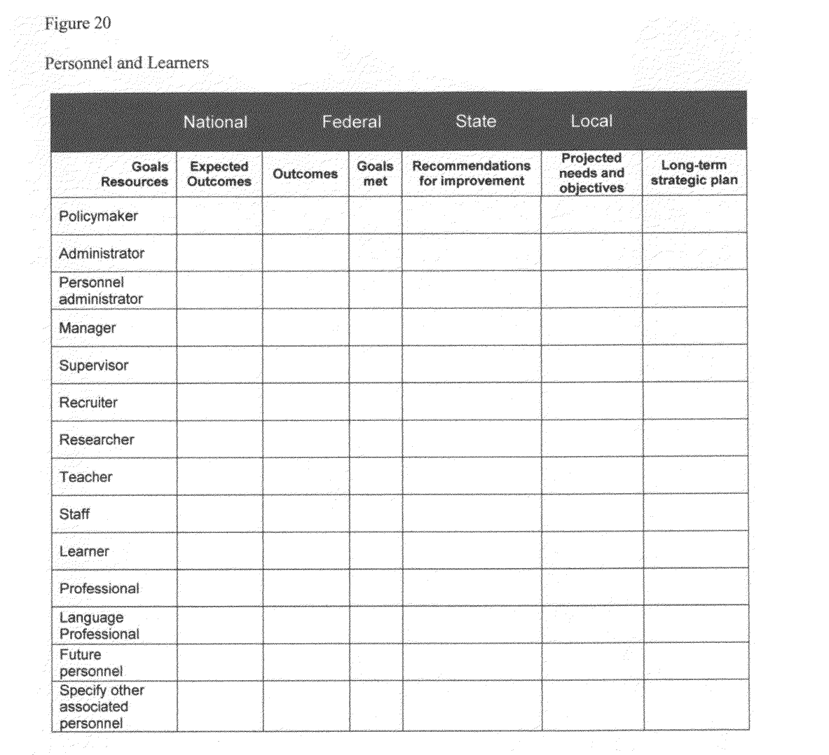

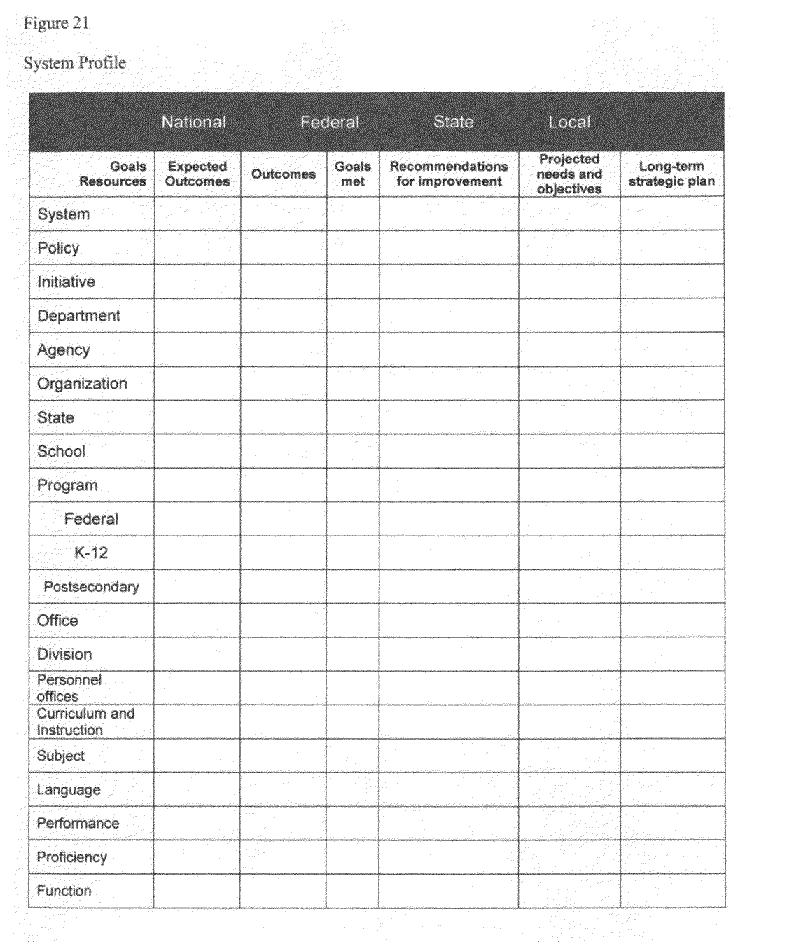

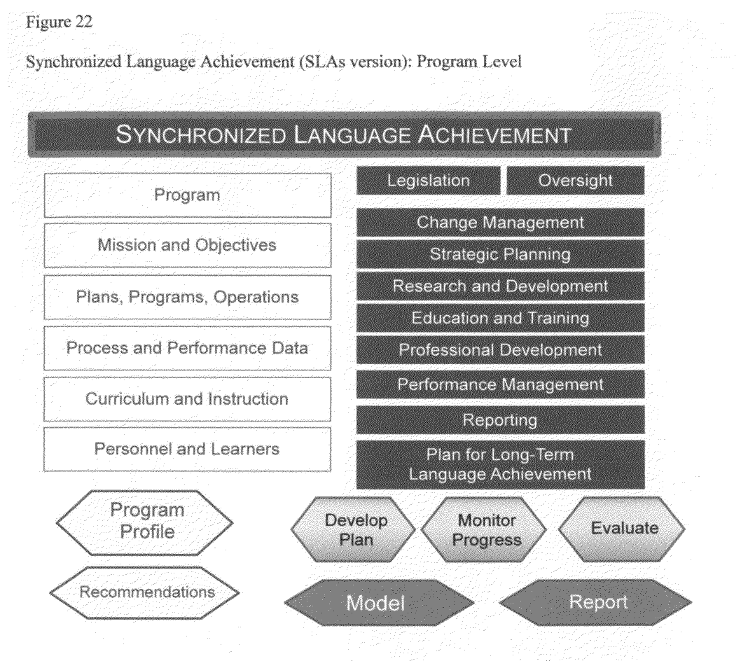

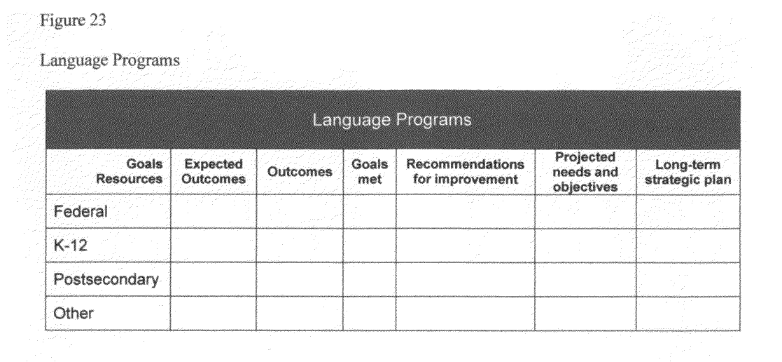

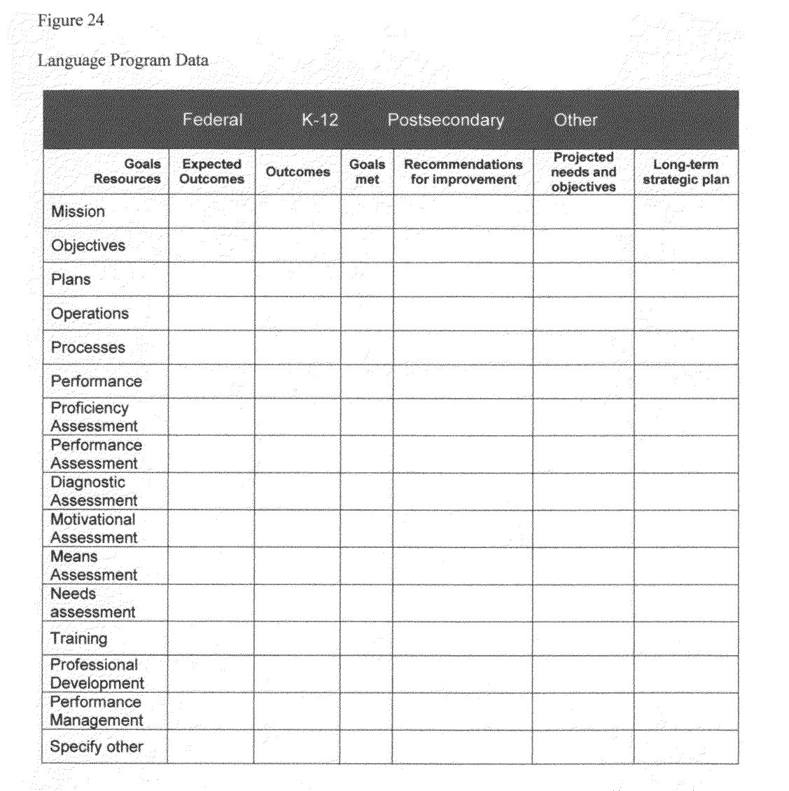

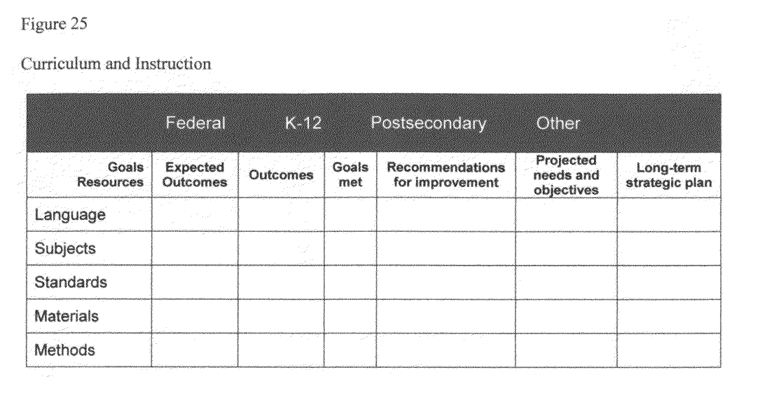

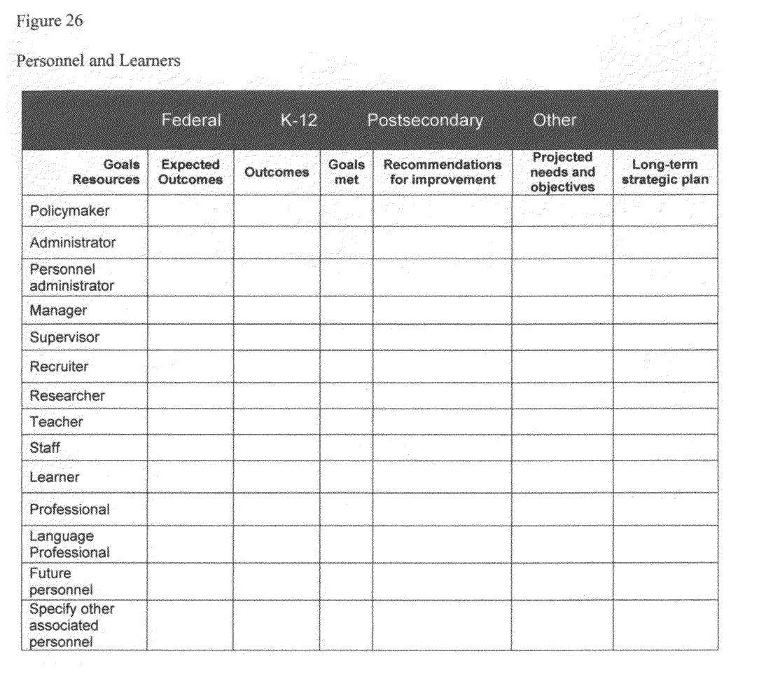

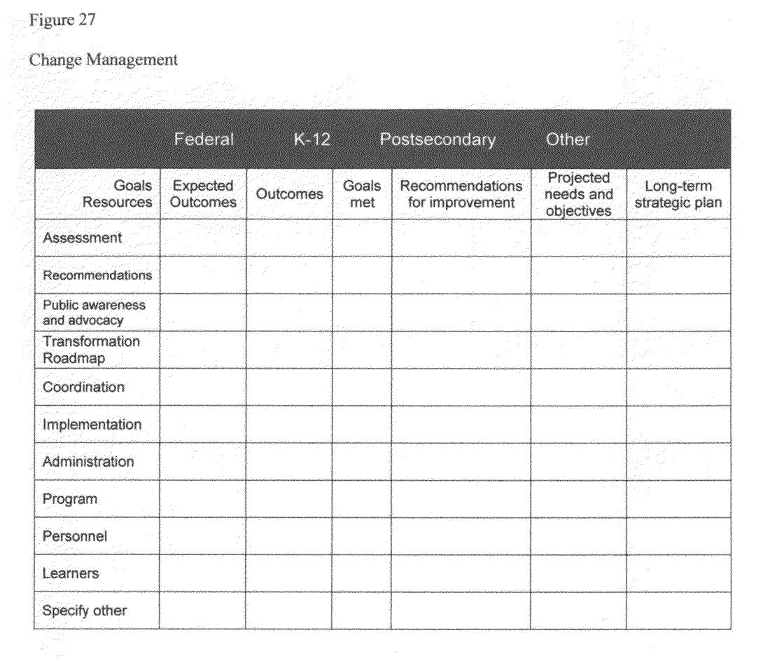

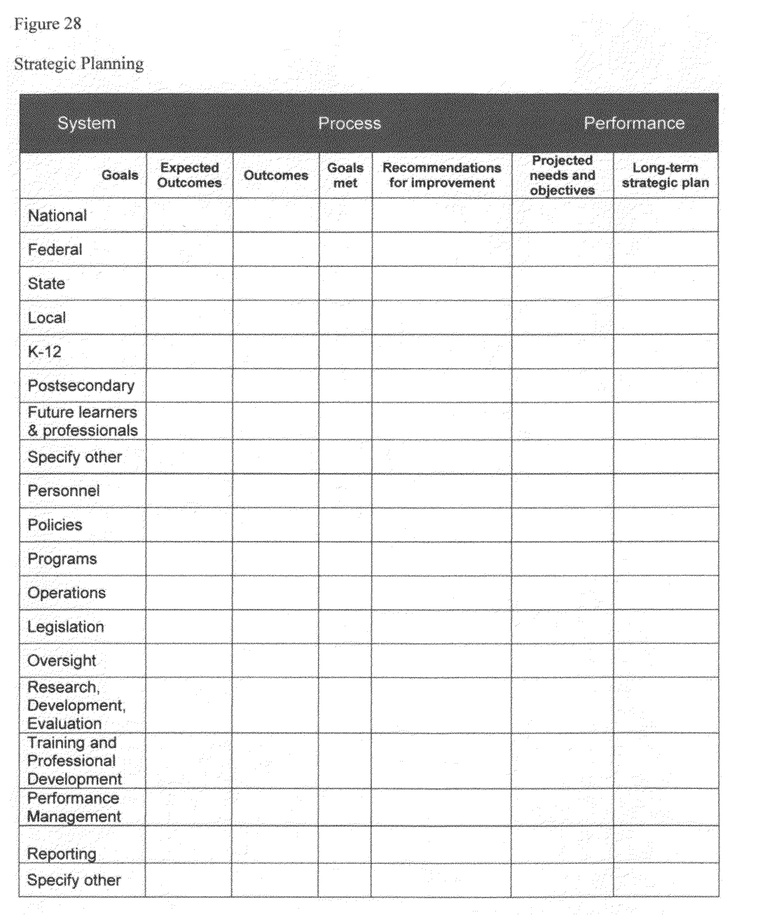

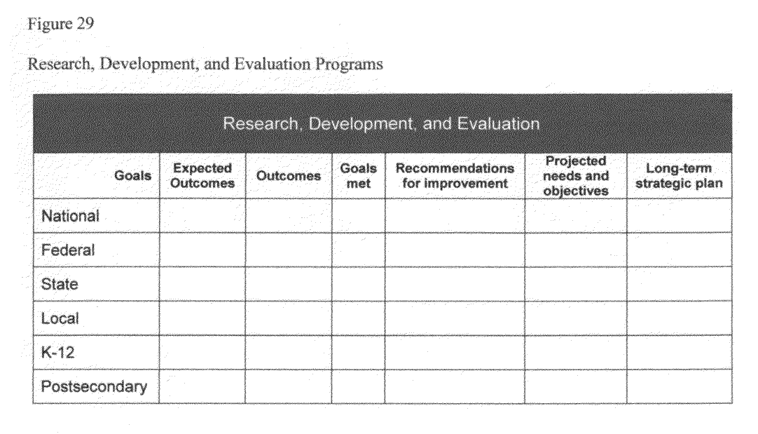

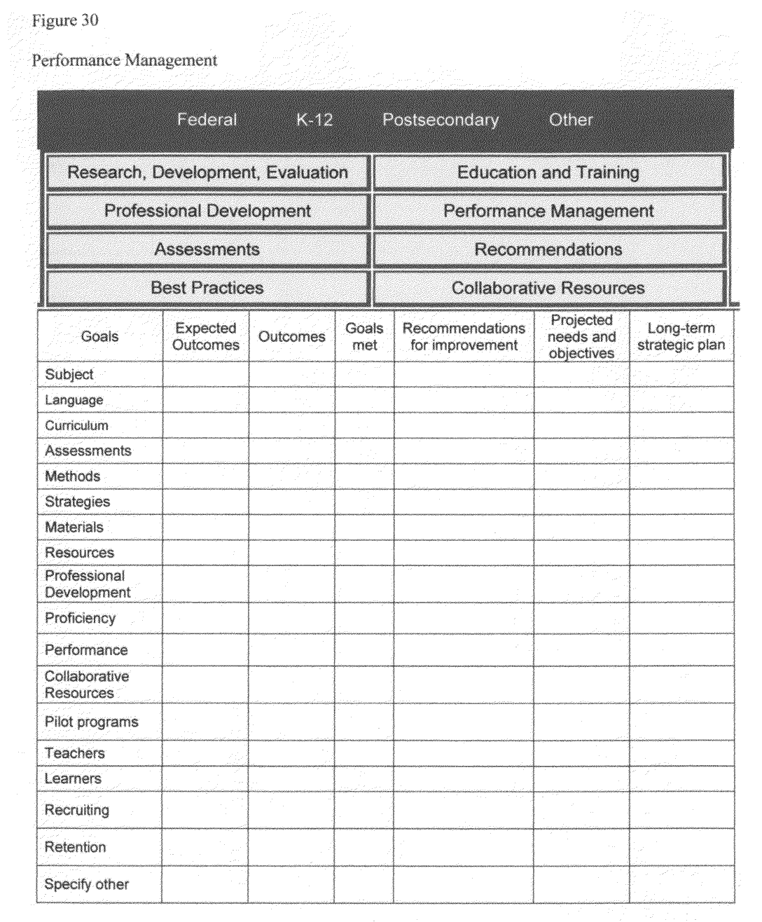

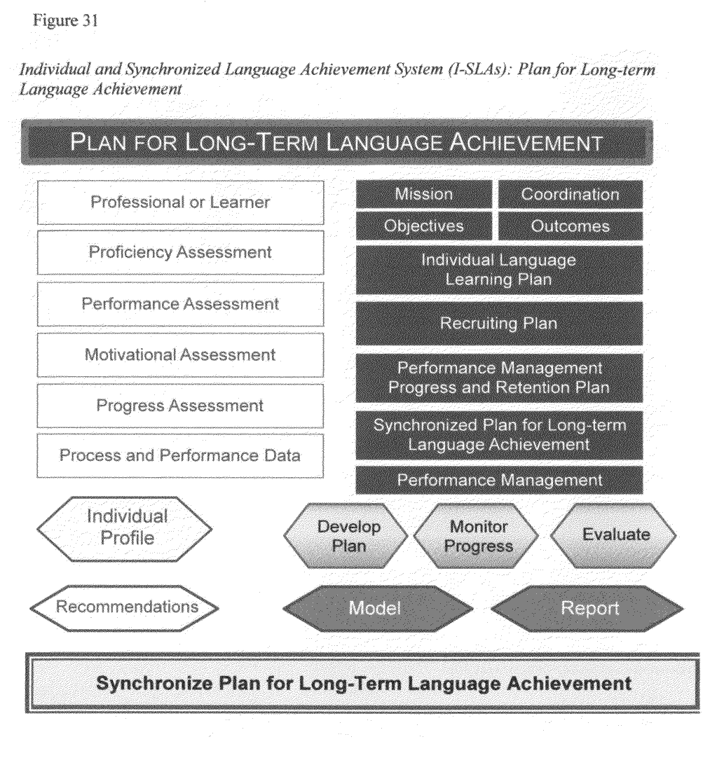

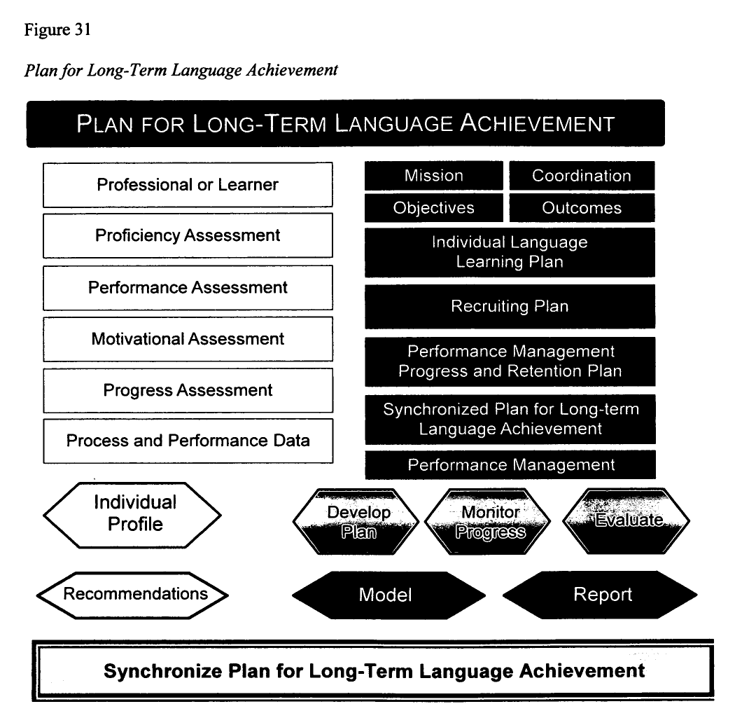

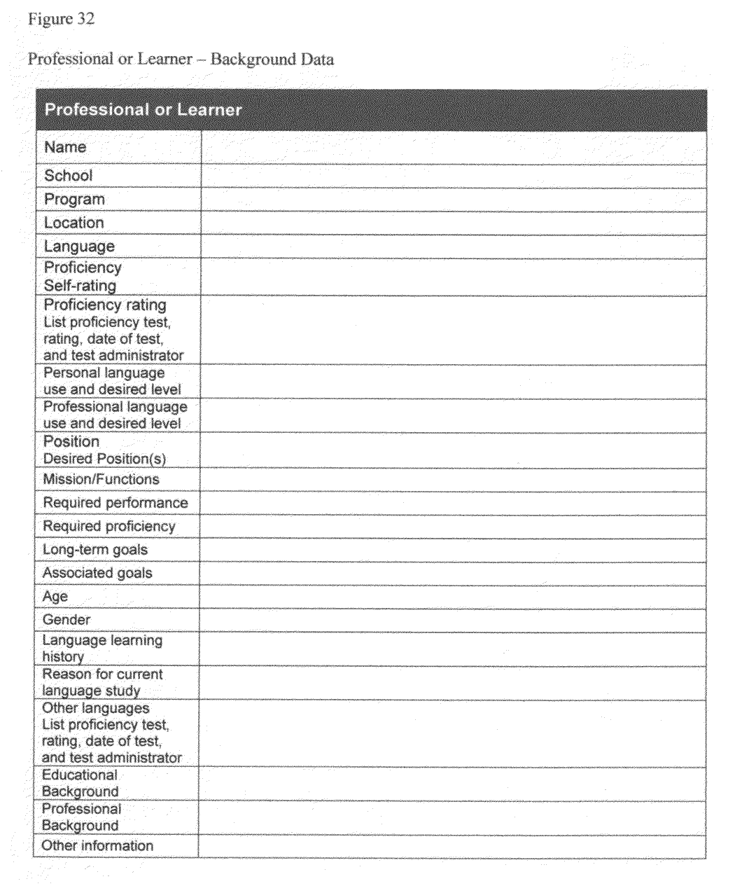

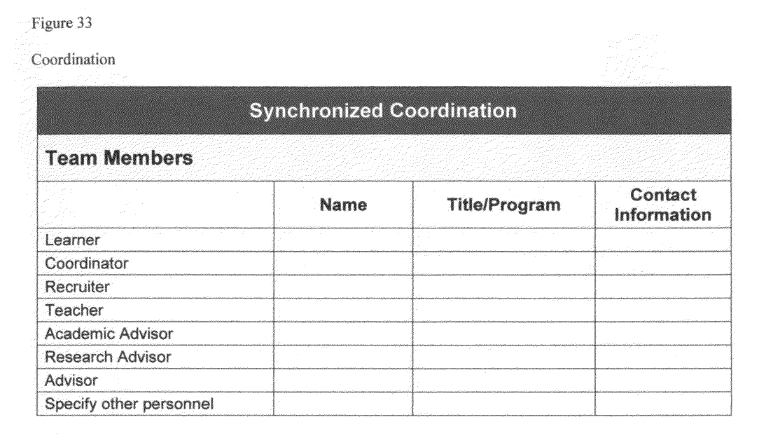

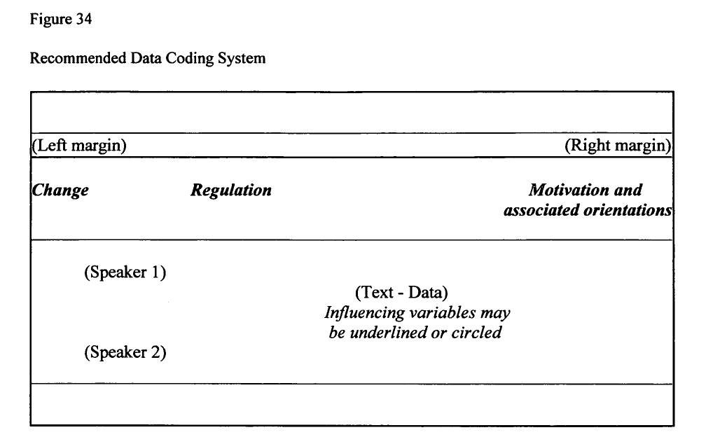

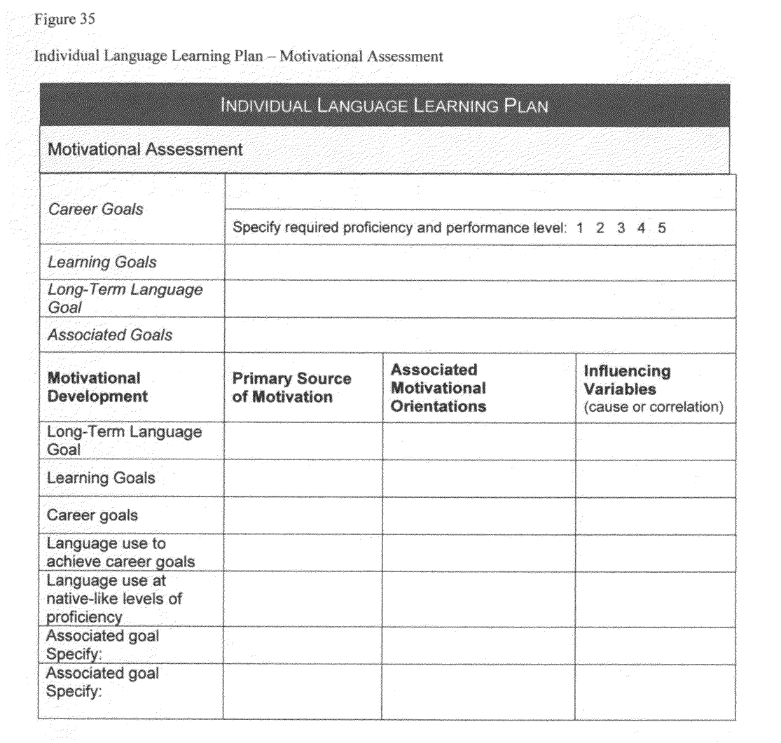

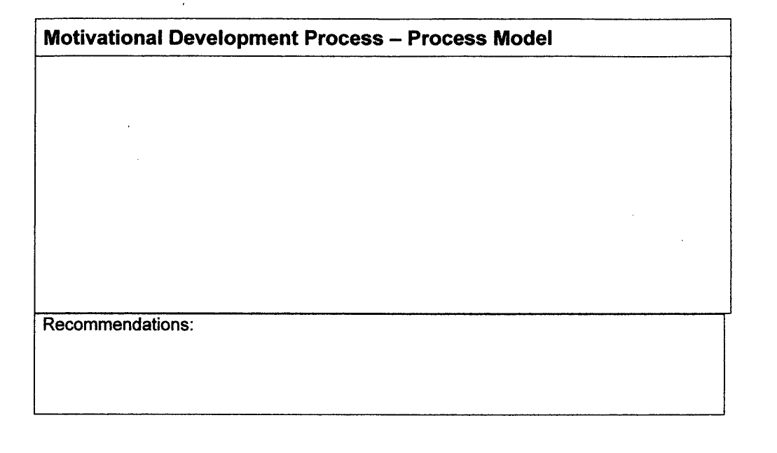

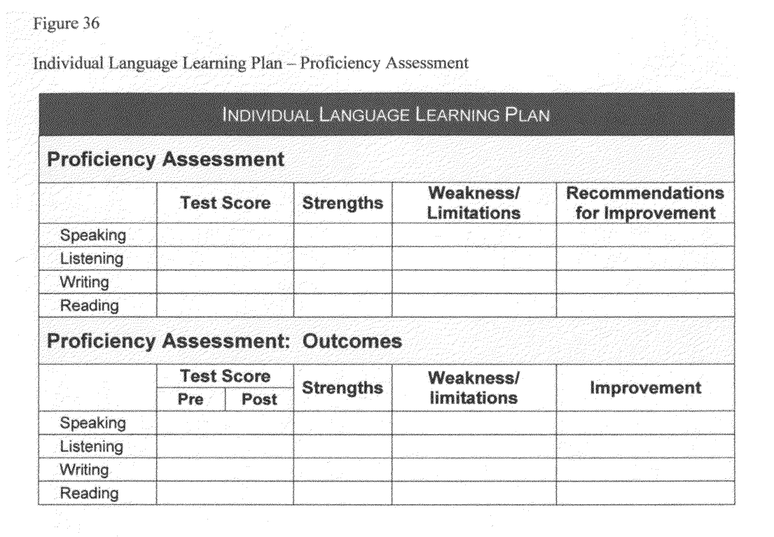

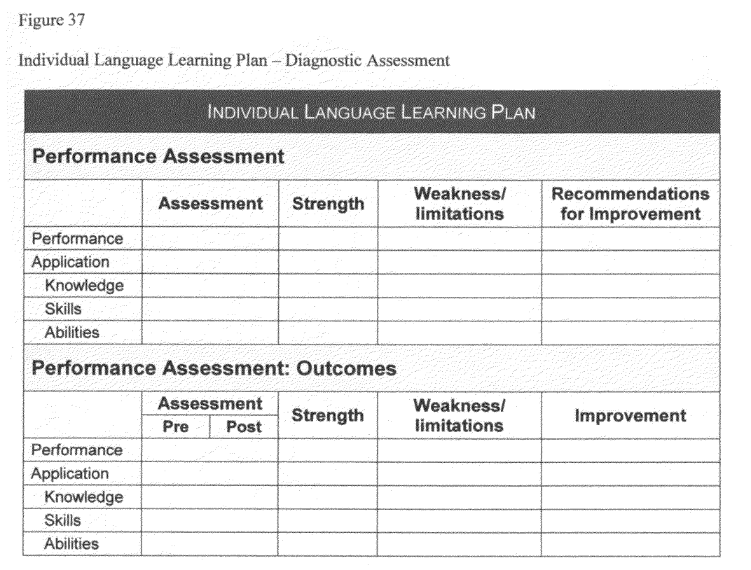

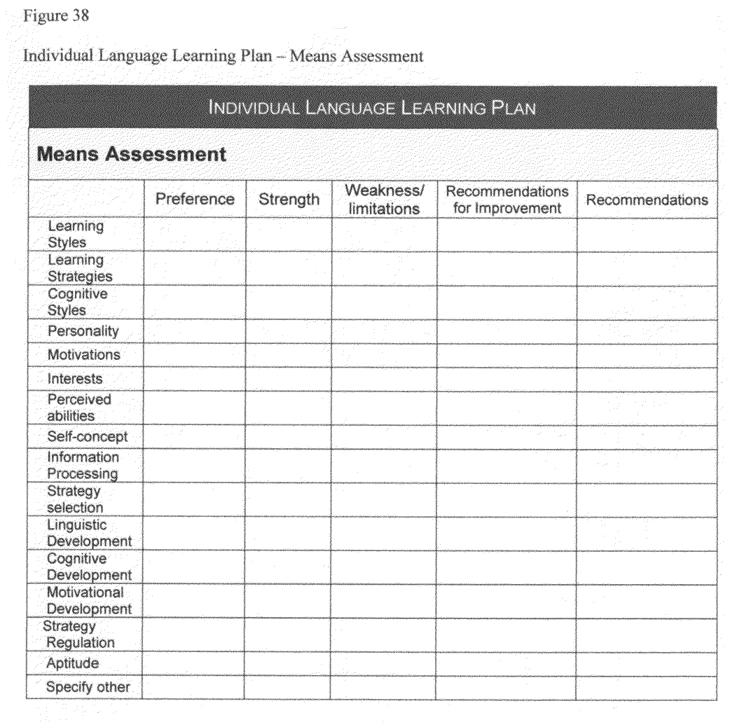

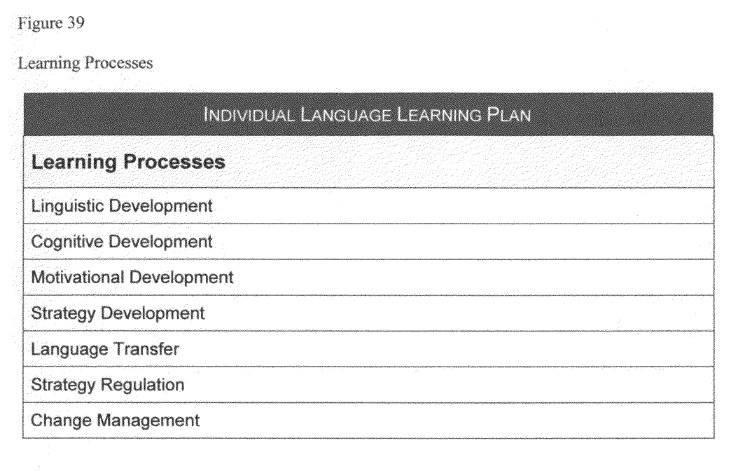

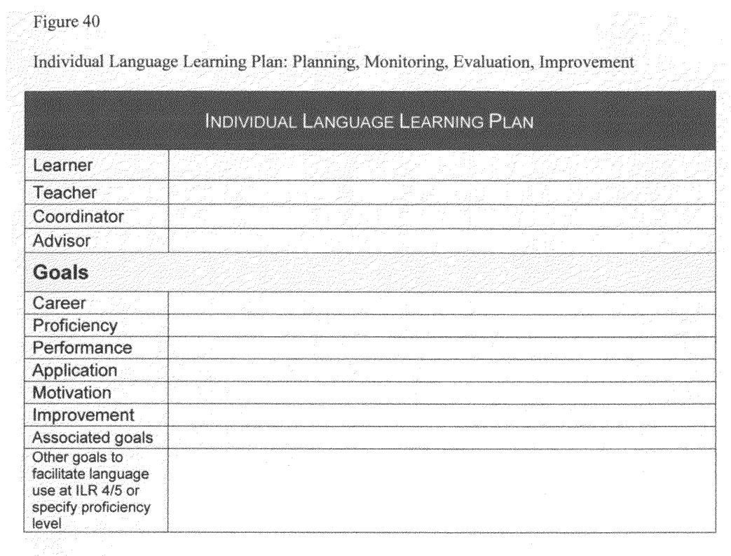

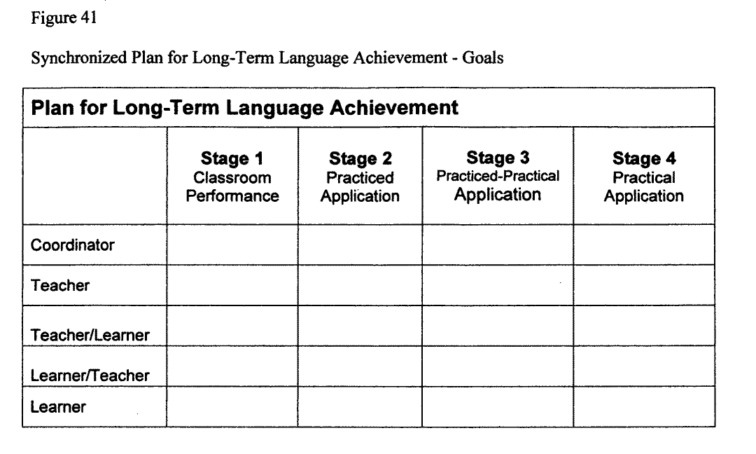

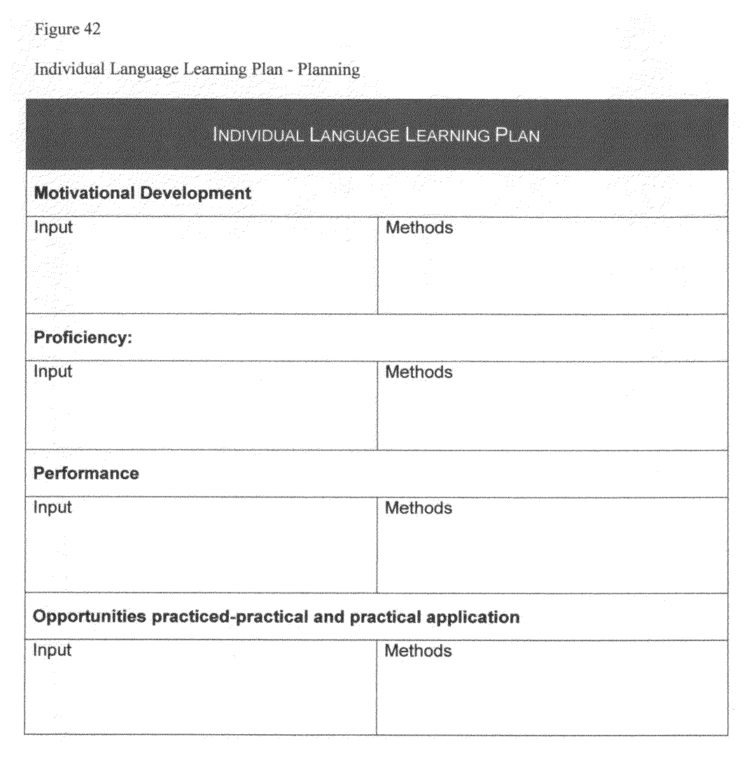

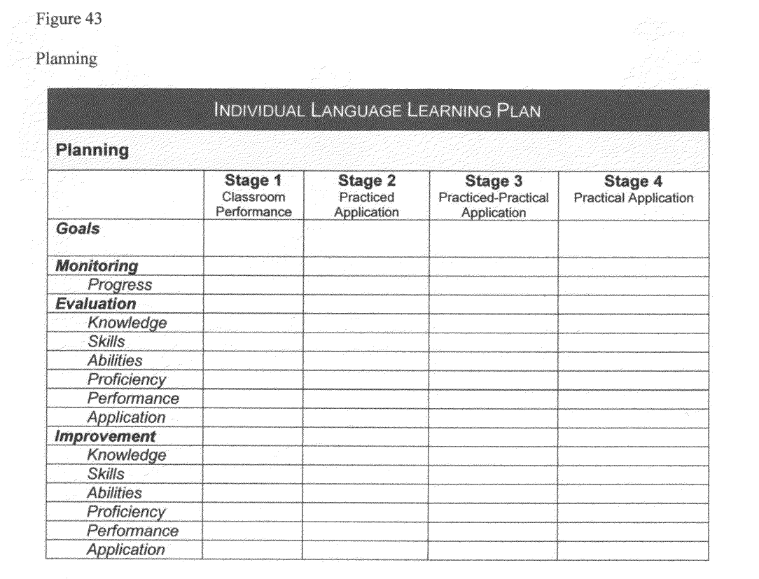

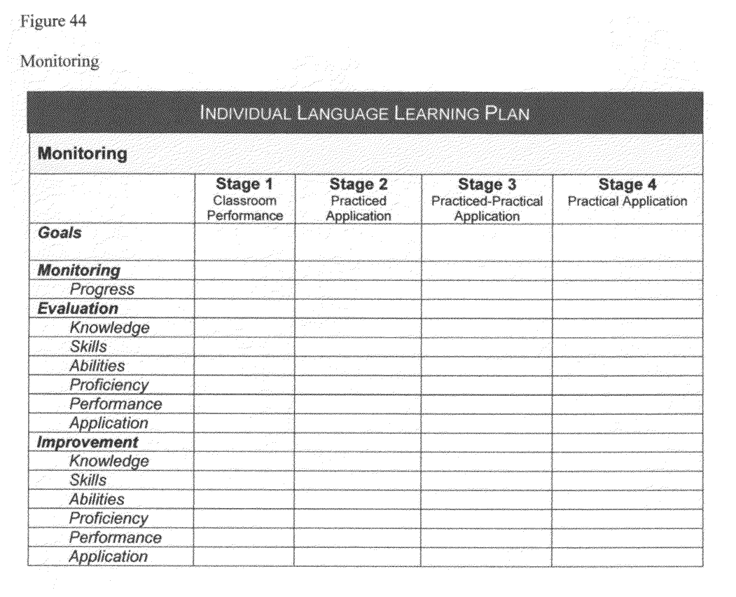

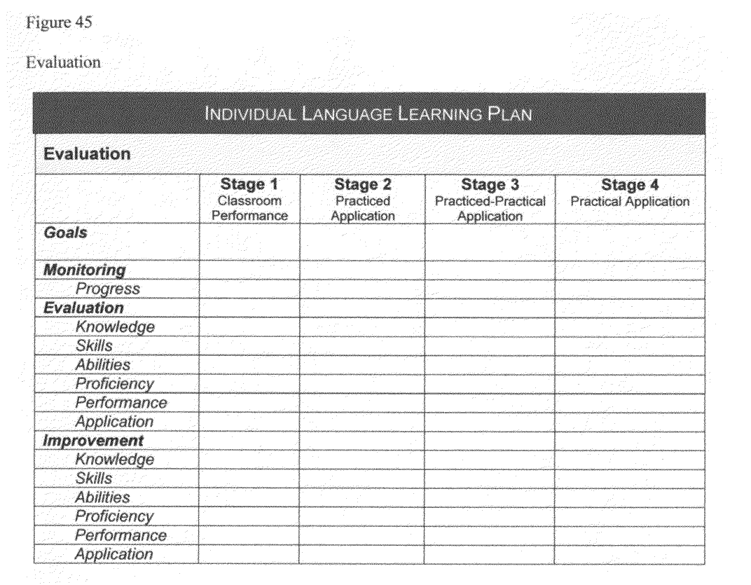

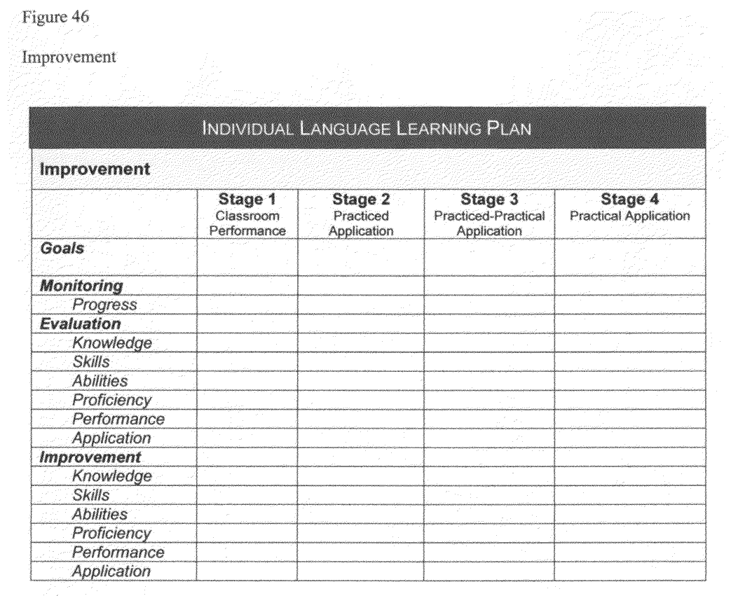

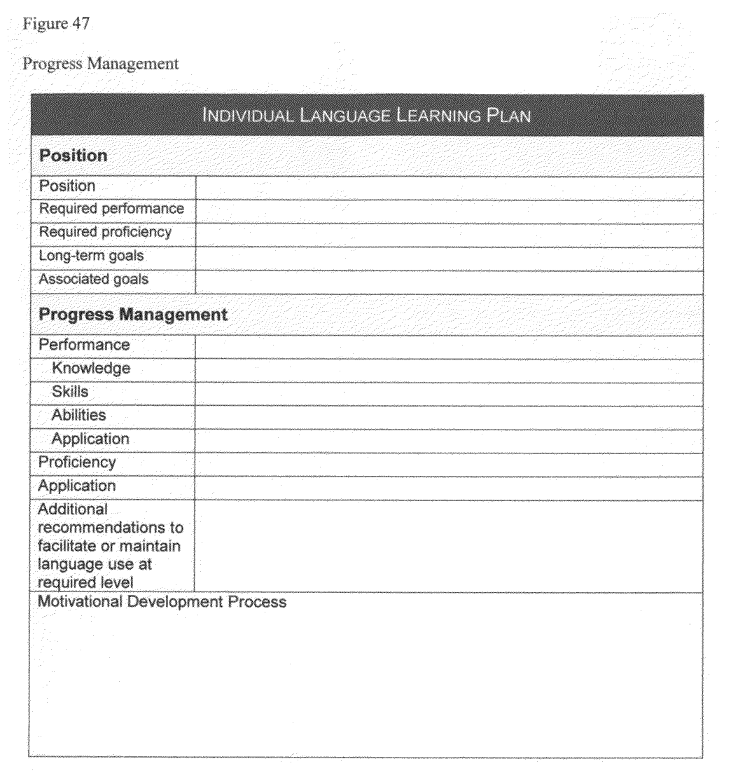

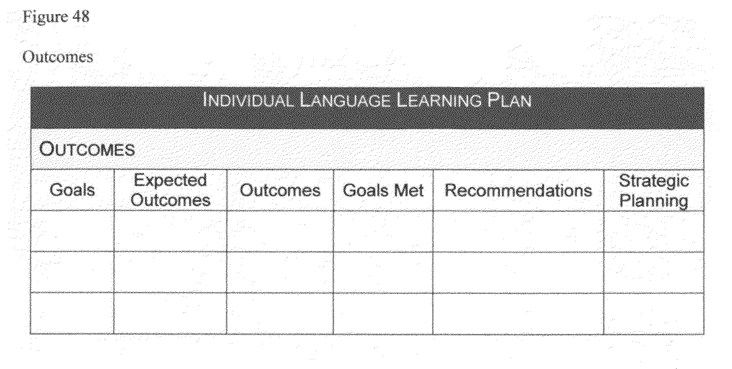

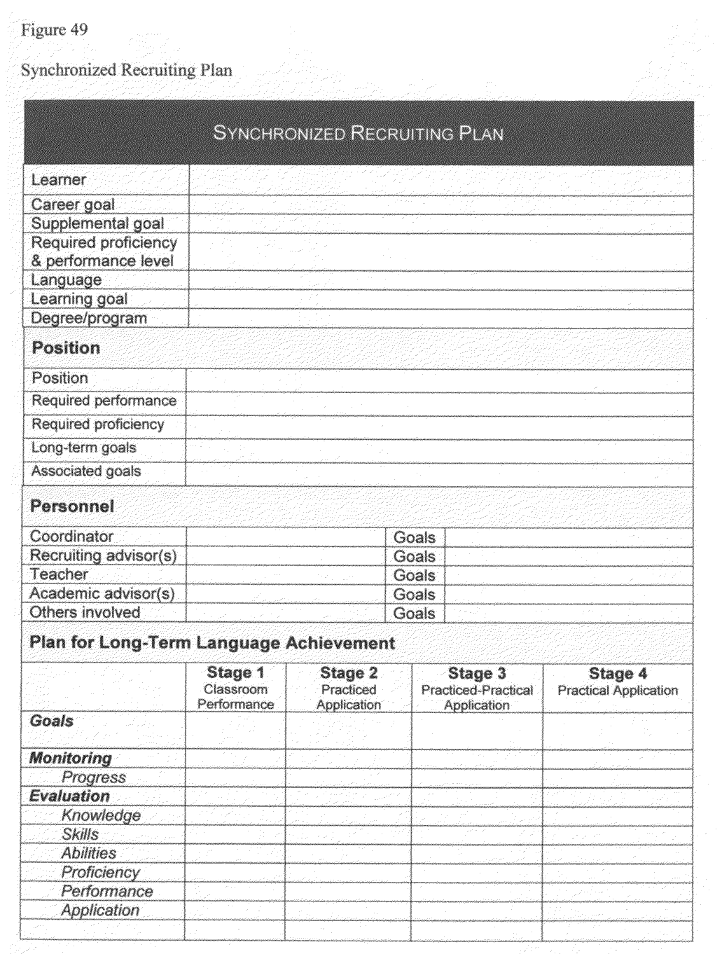

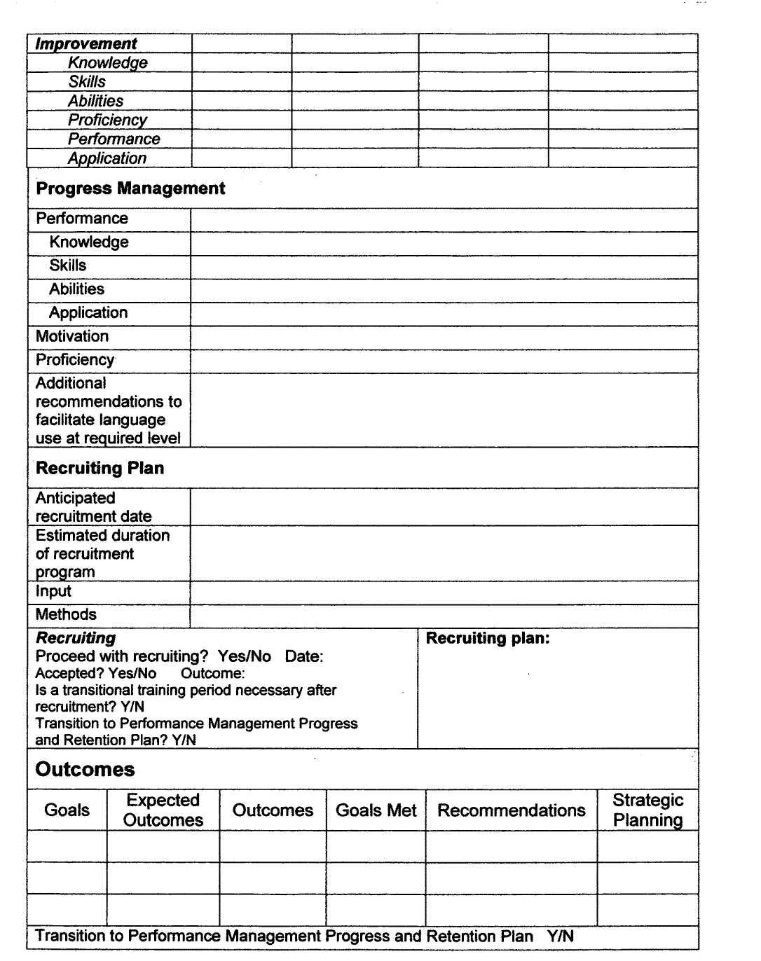

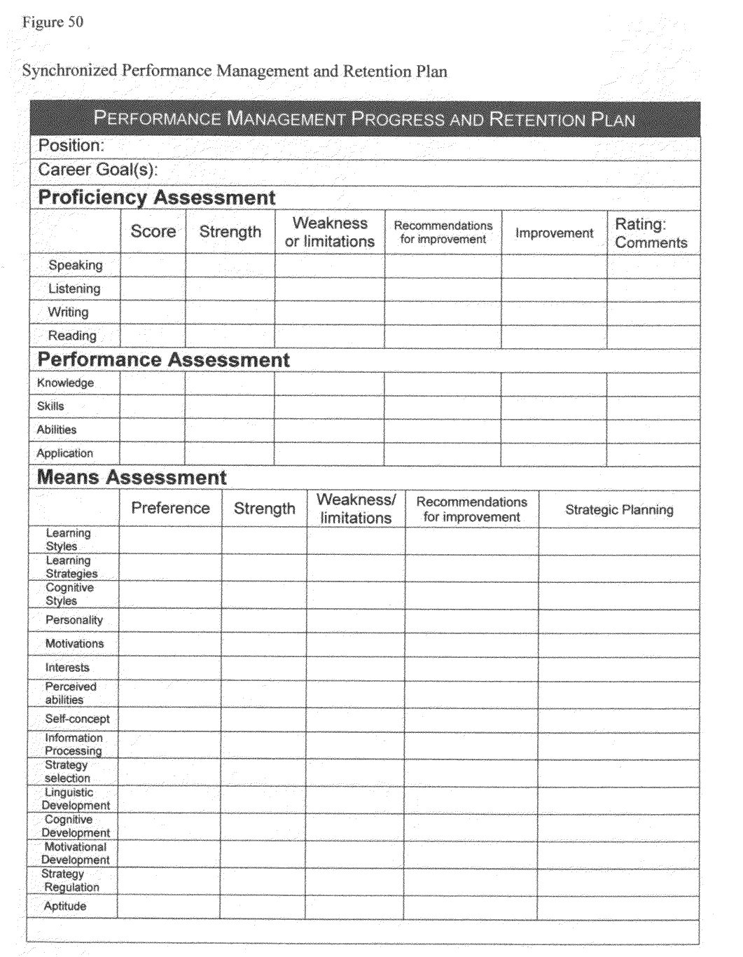

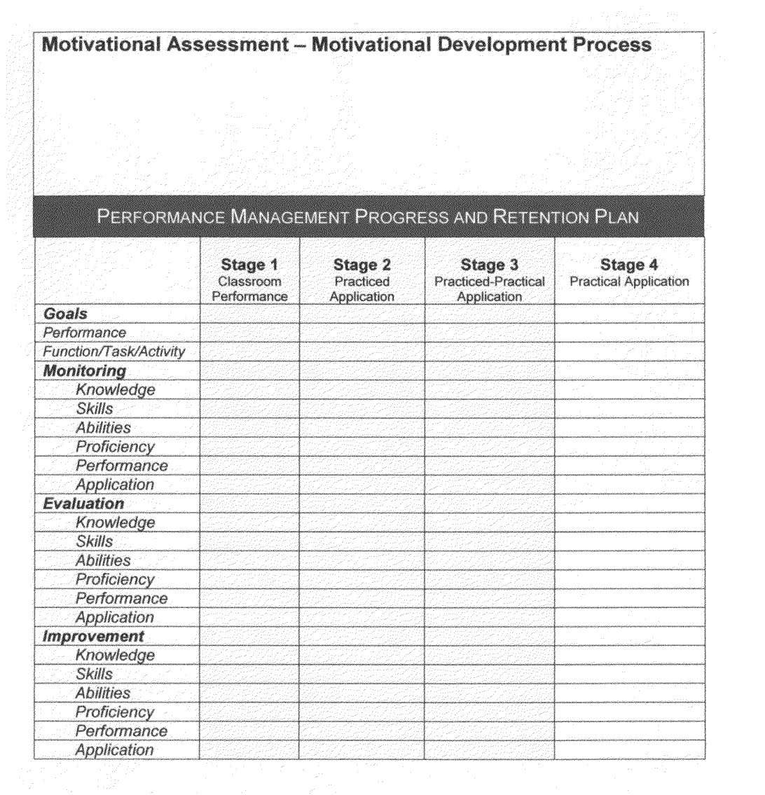

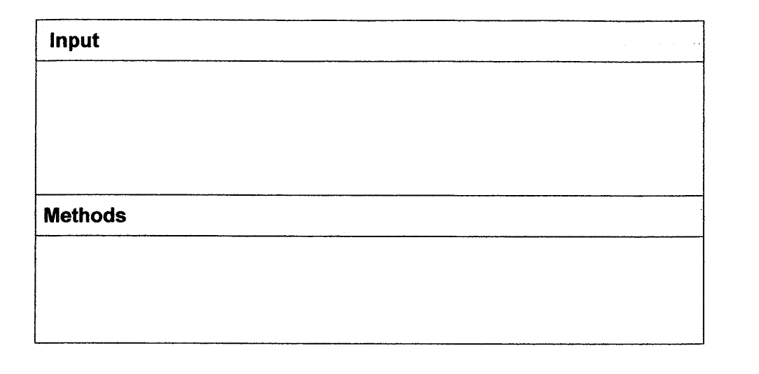

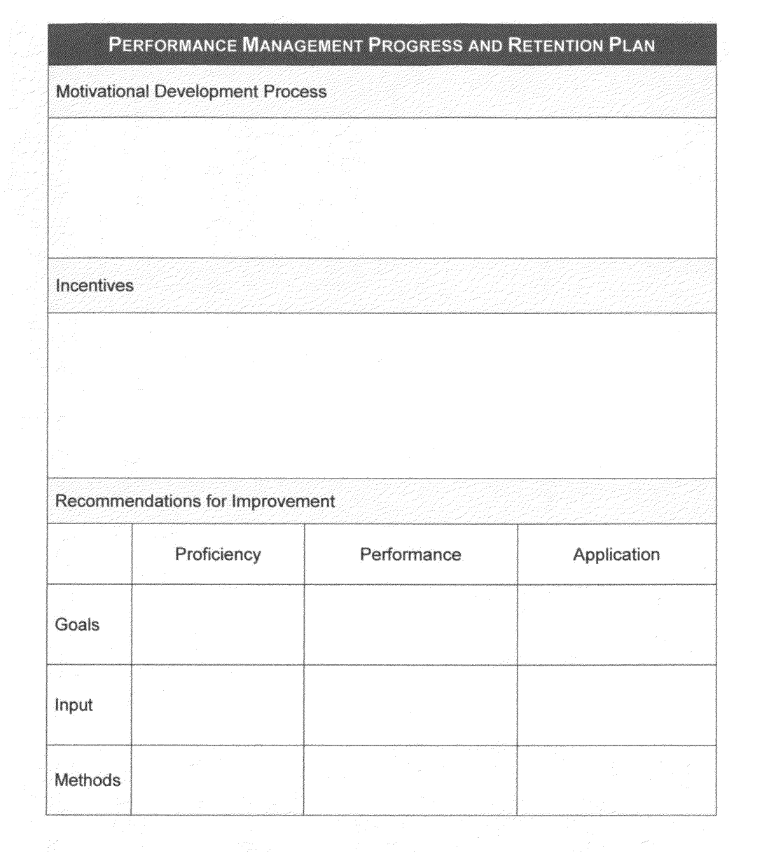

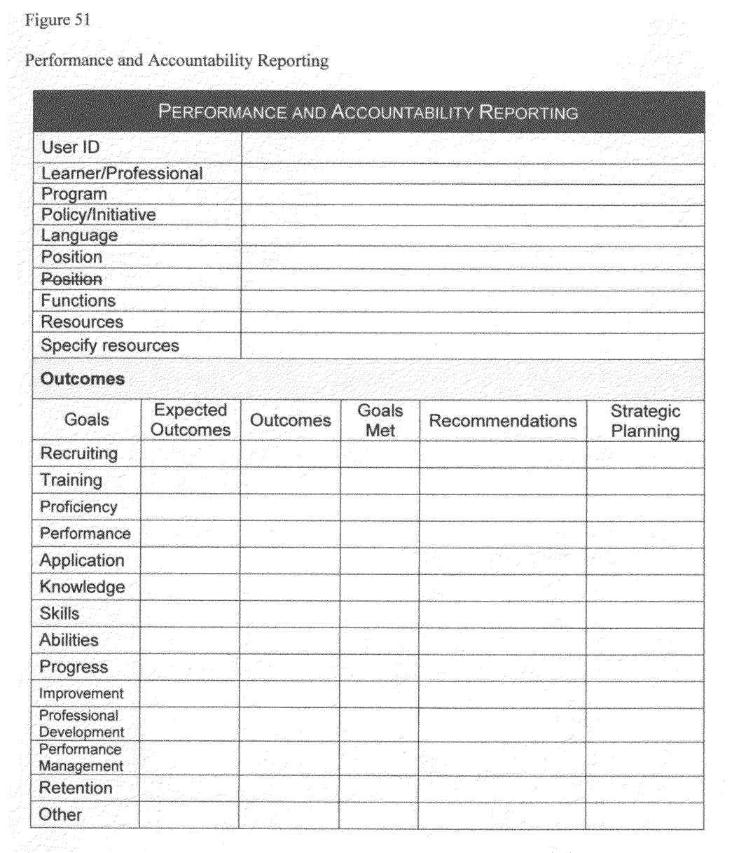

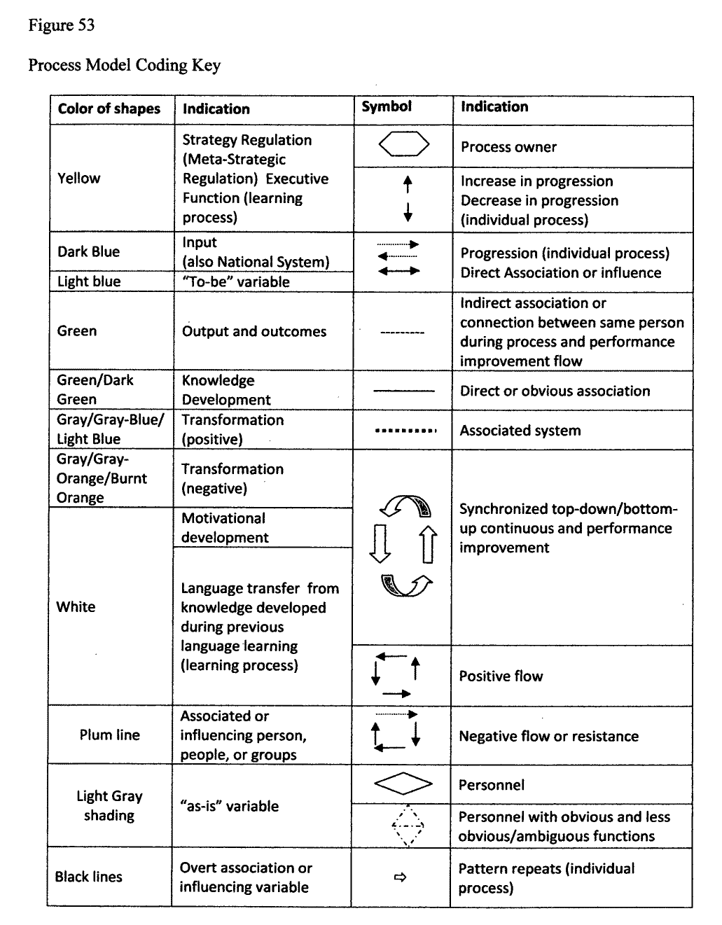

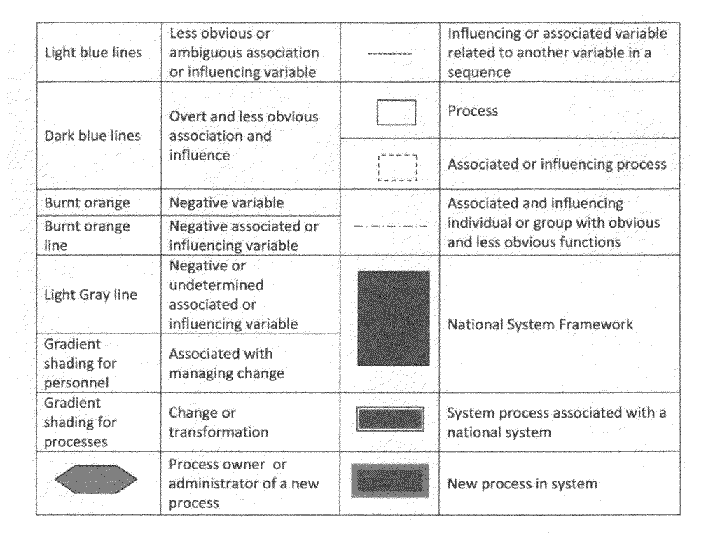

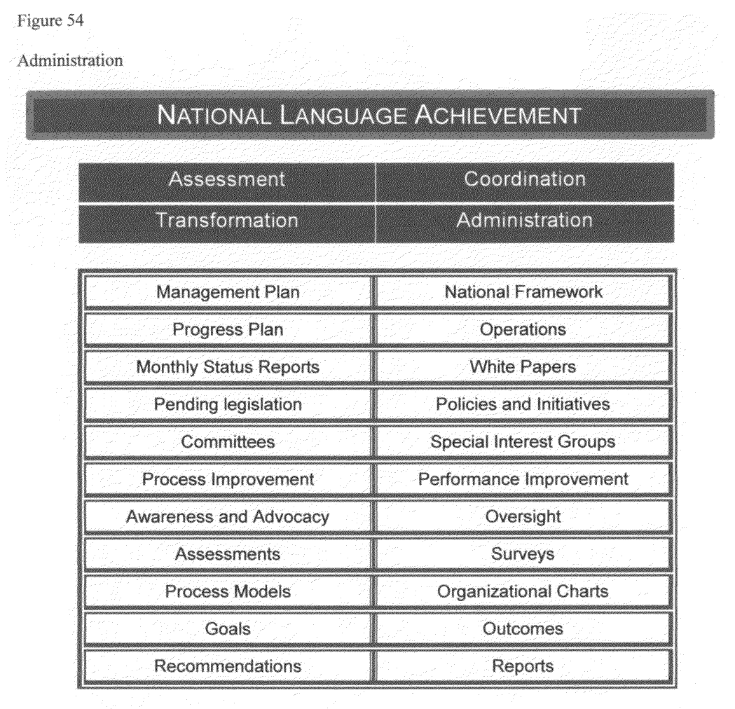

The user may develop frameworks and models and link these to reports. Report data may also be managed using frameworks and models in the Model feature to facilitate reporting. This feature may also be linked to the oversight feature in the administrator version. FIG. 1 provides an example of a framework model that may be produced using the Model and Report features in this system.

What I claim as my invention is as follows:

1) National Language Achievement Data Management and Reporting System (NLAs)
Data Management and Reporting processes and software design for:
Nationwide System Assessments and System Profiles
National Language Coordination (National System Coordination)
National Language Transformation (National System Transformation)

2) Synchronized Language Achievement Data Management and Reporting System (SLAs)
Data Management and Reporting processes and software design for:
Program Evaluation
Program Profiles

3) Individual Language Achievement, Data Management and Reporting System (I-SLAs)
Data Management and Reporting processes and software design for:
Plan for Long-Term Language Achievement (Individual)
Plan for Long-Term Language Achievement (Synchronized)
Individual Language Learning Plan
Individual Assessments and Individual Profiles
Synchronized Recruiting Plan
Synchronized Performance Management Progress and Retention Plan

4) Customized Language Achievement Software System (CLASS):
Data Management and Reporting processes and software design for:
Nationwide System, Program, and Individual Assessments
System Profiles, Program Profiles, and Individual Profiles
Administration and oversight associated with national language coordination
Administration and oversight associated with national systems
CLASS includes NLAs, SLAs, and I-SLAs (claims 1-3)
